(19) United States
(12) Patent Application Publication
(10) Pub. No.: US 2026/0303698 A1
(43) Pub. Date: Oct. 1, 2026

(54) METHOD OF CONTROLLING FOR A ROS2 (ROBOT OPERATING SYSTEM 2) ROBOT

(71) Applicant: SAMSUNG ELECTRONICS CO., LTD., Suwon-si (KR)

(72) Inventors: Haris Kasminto AJI, Jakarta (ID); Adrian, Jakarta (ID); Amri Shodiq, Jakarta (ID); Erlina Rohmawati, Jakarta (ID); Mario Kusuma, Jakarta (ID); Mochamad Havid Albar Purnomo, Jakarta (ID); Rivan, Jakarta (ID)

(73) Assignee: SAMSUNG ELECTRONICS CO., LTD., Suwon-si (KR)

(21) Appl. No.: 19/090,031

(22) Filed: Mar. 25, 2025

Related U.S. Application Data
(63) Continuation of application No. PCT/IB2024/050070, filed on Jan. 4, 2024.

(30) Foreign Application Priority Data
Jan. 5, 2023 (ID) P00202300120

(51) Int. Cl. H04L 67/00; H04L 9/40; H04L 67/12; H04W 4/38

(52) U.S. Cl. CPC H04L 67/34; H04L 63/0807; H04L 67/12; H04W 4/38

(57) ABSTRACT

A method of controlling for a ROS2 (Robot Operating System 2) robot includes: enabling a control of the ROS2 robot through an Internet of Things (IoT) client application, where the enabling the control of the ROS2 robot includes: applying a robot configuration process including generating a robot application using a developer workspace, and inputting a robot serial number, a device identification, a public key and a task list into an IoT cloud, applying a robot onboarding mechanism process including onboarding the ROS2 robot to the IoT client application, and configuring, by a robot software development kit (SDK) node, communication among the ROS2 robot and the IoT cloud, applying a robot operational process including bridging communication, the robot SDK node, among the ROS2 robot, the IoT cloud and the IoT client application.

### CROSS-REFERENCE TO RELATED APPLICATION(S)

This application is a continuation of International Application No. PCT/IB 2024/050070, filed on Jan. 4, 2024, which is based on and claims priority to Indonesian Patent Application No. P00202300120, filed on Jan. 5, 2023, in the Indonesian Patent Office, the disclosures of which are incorporated by reference herein in their entireties.

### BACKGROUND

### 1. Field

This disclosure relates to a system and method of controlling for a ROS2 Robot using IoT Client App.

### 2. Description of Related Art

Internet of Things (IoT) and Robotics systems are becoming more related today as the use of both devices can be integrated with each other. The integration of Robot to IoT ecosystem is often called as Internet of Robotic Things (IoRT), which is a concept where intelligent devices can monitor events, fuse sensor data from variety of sources, use local and distributed intelligence to determine the best course of action, and can control or manipulate objects of the physical world.

The use of IoT and Robot devices for domestic or home purposes can be used as an example to describe IoRT. The adoption of robot vacuums and personal assistants is growing massively these days as awareness to smart home usage is increasing. In the future, it is expected that domestic robots will carry most of household chores like dusting, laundry and cleaning dishes.

Most of today's robotics devices are using Robot Operating System (ROS), specifically ROS2 for commercial robots. ROS2 was designed to use DDS (Data Distribution Service) communication protocol to communicate between nodes. Since most IoT devices are using a MQTT (Message Queue Telemetry Transport) protocol to communicate with IoT server, there is a need to create a communication bridge for supporting ROS2 robots to communicate with IoT server with MQTT protocol.

Currently, each IoT device and robot producer can have different mobile apps to control the devices. This makes it impossible to coordinate the activities of different devices. Thus, there is a need to enable Automation system by using a single application (App) to make controlling multiple robot and IoT devices possible.

In related art, several patents and public papers that explore various methods to manage robot via IoT Cloud have been considered. However, there is a need for methods on how to leverage all of those topics into a system and method that bridge DDS protocol and MQTT protocol to control ROS2 robot via IoT Cloud.

In the related art, US20190089799A1 proposed a method of managing communication between cloud and heterogeneous devices across networks. The method relates to the deployment of a communication bridge on each of the communication network to the communication broker on the cloud. This art is using Advanced Message Queuing Protocol (AMQP) to implement the communication bridges, as speaker and listener, with RabbitMQ as the communication broker. Meanwhile, the objective of our proposed invention is to provide a way to bridge communication between DDS and MQTT by adding a Robot software development kit (SDK) inside ROS2 Robot so it can connect to IoT Client App through the IoT Cloud server.

A second related art, US20200233436A1 proposed a cloud-based robotic control systems and methods. The method relates to creating a communication bridge between ROS1 robot that uses RTSP protocol to cloud that uses MQTT protocol. Our proposed invention is to create communication bridge between DDS protocol used for ROS2 Robot and MQTT protocol used for IoT Cloud service.

A third related art, KR20160144794A proposed a remote management system for apparatus having MQTT and DDS client module. This art focuses on unique bridges, such as MQTT to MQTT, and DDS to DDS, and does not support for robotic devices that are DDS to MQTT in nature. However, this art does not provide way to bridge communication inside ROS2 that used a DDS communication protocol with IoT Cloud that used MQTT communication protocol.

Fourth Related Art, KR101890310B1 proposed a method to provide adaptor between DDS to MQTT. The objective of this art is to build an adapter between devices which use Bluetooth Low Energy (BLE) and Zigbee with the broker. The system added a data conversion unit for converting the DDS topic to MQTT with a data management unit in the middle for storing the DDS and MQTT topic into general data. However, this art does not provide methods for supporting ROS2 robot on IoT system including DDS to MQTT bridge adaptor, onboarding, and media transfer system.

Most of the related art focuses on providing some part of our invention. Whereas, our invention proposes a novel method to

### SUMMARY

Provided is a system and method for establishing communication between ROS2 Robot and IoT Cloud service using Robot SDK to process command data, media data, action data for robot, and manage collaborative bridge and validation process.

Further, provided is a system and method to bridge communication between ROS2 Robot and IoT Cloud service using Robot SDK Node embedded on the Robot Operating System.

Additional aspects will be set forth in part in the description which follows and, in part, will be apparent from the description, or may be learned by practice of the presented embodiments.

According to an aspect of an embodiment, a method of controlling for a ROS2(Robot Operating System 2) robot, the method may include: enabling a control of the ROS2robot through an Internet of Things (IoT) client application, where the enabling the control of the ROS2 robot includes: applying a robot configuration process including generating a robot application using a developer workspace, and inputting a robot serial number, a device identification, a public key and a task list into an IoT cloud, applying a robot onboarding mechanism process including onboarding the ROS2 robot to the IoT client application, and configuring, by a robot software development kit (SDK) node, communication among the ROS2 robot and the IoT cloud, applying a robot operational process including bridging communication, the robot SDK node, among the ROS2 robot, the IoT cloud and the IoT client application, and applying an IoT controller user experience (UX) component generation process including generating a page in the IoT client application, based on capabilities of the ROS2 robot, to control the ROS2 robot; and streaming media, directly or indirectly, through the robot SDK node to process command data, media data, action data and a collaborative bridge and validation process.

The ROS2 robot may include a ROS2 operating system.

The IoT cloud may include an IoT server that is accessible by plurality of robots and IoT devices.

The streaming media, directly or indirectly, may include sending audio or video data from the ROS2 robot to the IoT client application in real time.

The IoT client application may be installed on a device for controlling IoT device, where the device is mobile phone or smart watch.

The applying the robot configuration process may further include: generating the robot SDK node using the developer workspace, installing a robot SDK before the onboarding of the ROS2 robot to the IoT client application, and inputting the robot serial number, the device identification, the public key and the task list into the IoT cloud.

The robot onboarding mechanism process may further include: connecting the ROS2 robot to a WiFi that is connected to a mobile phone on which the IoT client application is installed, connecting the ROS2 robot to the IoT client application and retrieving the IoT cloud and user information to obtain a cloud configuration, where the ROS2 robot is connected to the WiFi based on one of a WiFi configuration or the cloud configuration, connecting, by the robot SDK node, the ROS2 robot to the IoT client application to configure a communication between the ROS2 robot and the IoT cloud based on a device configuration and the cloud configuration, obtaining user information via the IoT cloud based on an access token included in the cloud configuration, generating a link between the ROS2 robot and the IoT client application based on the user information, notifying the IoT client application via the IoT cloud that the ROS2 robot is linked to the IoT client application, and controlling the ROS2 robot through the IoT cloud on the IoT client application.

The applying the robot operational process may include: applying an integrated bridge inside the robot SDK node to bridge communication among the ROS2 robot, the IoT cloud and the IoT client application, where the integrated bridge is configured to bridge communications of IoT automation features, routine features and scene features to the ROS2 robot via the IoT client application, applying a media transfer process to send real time audio or video media from the ROS2 robot to the IoT client application using a direct and indirect media stream, and applying a security integration process to secure communication among ROS2 robot, the IoT cloud and the IoT client application.

The applying the IoT controller UX component generation process may further include: generating the page as a user interface (UI) in the IoT client application, based on the capabilities of the ROS2 robot, to control the ROS2 robot and indicate a status of the ROS2robot, and controlling the capabilities of the ROS2 robot based on the UI.

The applying the robot onboarding mechanism process may further include: configuring the communication automatically among the ROS2 robot, the IoT cloud and the IoT client application, building the robot SDK node with integration between ROS2 packages and at least one a ROS2 Launch Packages, a Message Pack Library, a Message Queue Telemetry Transport (MQTT) client, a Web Server, an Open Source Computer Vision Library (OpenCV library), a Websocket, a Web Real-Time-Communication (WebRTC), or a Device and Media SDK, using the Message Pack Library for a ROS2-to-MQTT bridge serialization message data and deserialization message data to convert a ROS2 message format to a MQTT JavaScript Object Notation (JSON) message format, and to convert the MQTT JSON message format to the ROS2 message format, and using the OpenCV library for image processing within robot SDK node.

The applying the integrated bridge may include: using a command data processor to control and extract data from a data transformer, and construct a data format using an MQTT protocol for a device event, using a media data processor to control and extract data using a WebSocket protocol for media transfer, using an action data processor to control and extract data using a DDS protocol for action processing, using a collaborative bridge & validation processor to manage and validate incoming message data, and bridging communication among the ROS2 robot, the IoT cloud, and the IoT client application by using the command data processor, the media data processor, the action data processor, and the collaborative bridge & validation processor.

The applying the media transfer may include: setting direct streaming via a router of a local area network (LAN) as a priority option, based on a direct stream, sending a media streaming to the ROS2 robot in ROS2 message format via the router of the LAN, setting indirect streaming via internet to the IoT cloud as a secondary option, based on an indirect stream, converting a ROS2 message to data media streaming based on one of a ROS2 OpenCV library, WebSocket or WebRTC, applying a trigger time out, obtaining a value of the trigger time out, and based on the value of the trigger time out being greater than a limit value, switching from the direct streaming to the indirect streaming.

The applying the security integration process may include: generating a root administrator and an administrator, logging a username and password, generating the robot serial number, the device identification, a secret key and transport layer security (TLS), implementing security based on the robot serial number, the device identification and the secret key through the robot SDK node, and implementing the security among the IoT cloud, the ROS2 robot and the IoT client application, the security including of MQTT, Hypertext Transfer Protocol (HTTP) security, Real-Time Streaming Protocol (RTSP) security, and Data Distribution Service (DDS) security.

The using the command data processor may include: controlling incoming input data and transmitting output data for the device event from the IoT cloud via the MQTT protocol, using a data transporter to the input data to the command data processor, using a protocol manager to manage a work of a protocol and bridge a different protocol, using a data stack manager to store the input data, add a timestamp and send the input data to the action data processor based on the input data failing to flow, using a data forwarder to the input data to the media data processor for a collaborative bridge purpose, and using a status reporter to obtain a status of a current state of a robot action.

The using the media data processor may include: controlling incoming input data and transmitting output data for media streaming from the ROS2 robot and/or the device event from the command data processor, using a data transporter to the input data to the media data processor, using a protocol manager to manage a work of a protocol and bridge a different protocol, and using a data stack manager to store the input data, add a timestamp and send the input data to the action data processor based on the input data failing to flow.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is the general view of controlling ROS2 Robot using IoT Client App according to an embodiment;

FIG. 2 is the diagram of components for Robot SDK Node creation according to an embodiment;

FIG. 3 is the diagram for Robot Configuration according to an embodiment;

FIG. 4 is the diagram for Robot Onboarding process according to an embodiment;

FIG. 5 is the process of device event (task) and status update on Robot Operational according to an embodiment;

FIG. 6 is a sample for getting device event process according to an embodiment;

FIG. 7 is a sample of topic name and content according to an embodiment;

FIG. 8 is a sample of task type and action list according to an embodiment;

FIG. 9 is the process flow for media transfer according to an embodiment;

FIG. 10 is the process flow for Routine according to an embodiment;

FIG. 11 is the process flow for Scene according to an embodiment;

FIG. 12 is the process for generating UX component on IoT Client App according to an embodiment;

FIG. 13A is the process for robot onboarding to IoT Client App according to an embodiment;

FIG. 13B is the process for robot onboarding to IoT Client App according to an embodiment;

FIG. 14 is the various use case scenarios for using DDS-MQTT Communication Bridging Mechanism for ROS2 Robot and IoT Cloud according to an embodiment;

FIG. 15 is a sample use case scenario for delivery routine in hotel according to an embodiment;

FIG. 16 is a sample use case scenario for washing routine using robot butler and IoT devices according to an embodiment;

FIG. 17 is a sample use case scenario for delivery routine in apartment according to an embodiment;

FIG. 18 is a sample use case scenario for delivery scene in the hospital environment according to an embodiment;

FIG. 19 is a sample use case scenario for groceries scene in home environment according to an embodiment;

FIG. 20 is a sample use case scenario for dining room cleaning scene in home environment according to an embodiment;

FIG. 21 is a sample use case scenario for a scene using robot waiter and robot butler in restaurant environment according to an embodiment;

FIG. 22 is the illustration of direct and indirect streaming according to an embodiment;

FIG. 23 is the illustration of media streaming during a fire hazard at home scenario according to an embodiment;

FIG. 24 is the illustration for health care using robot scenario according to an embodiment;

FIG. 25 is the overall system architecture of integrated bridge inside Robot SDK Node according to an embodiment;

FIG. 26 is Integrated Bridge System diagram according to an embodiment;

FIG. 27 is the sample of end-to-end converting mechanism according to an embodiment;

FIG. 28 is Media Transfer flow for direct and indirect stream according to an embodiment;

FIG. 29 is switching flow for direct and indirect stream diagram according to an embodiment;

FIG. 30 is the differences between Direct Stream and Indirect Stream according to an embodiment;

FIG. 31 is Security Integration diagram according to an embodiment; and

FIG. 32 is the sample of secret key generation according to an embodiment.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

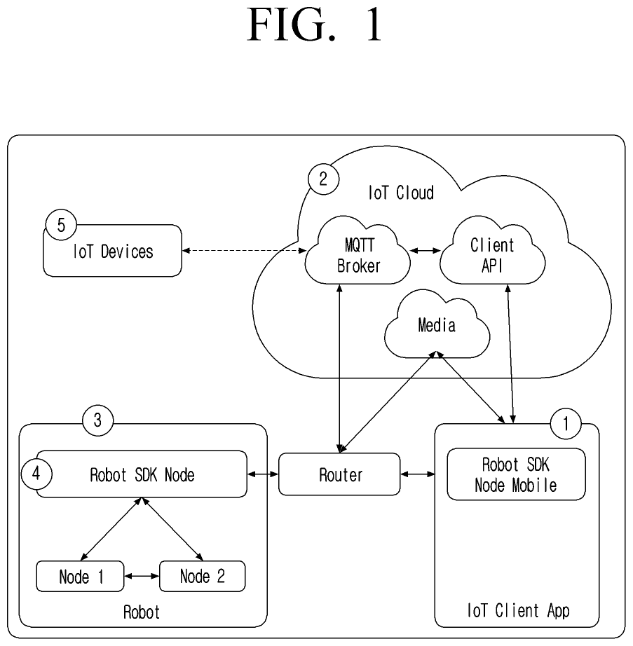

FIG. 1 describes the general view of controlling a ROS2 Robot using an IoT Client App by providing DDS to MQTT and WebSocket bridges for interaction between the ROS2 and the IoT Cloud. One or more embodiments of this disclosure will introduce the integration among the ROS2 Robot, the IoT Cloud, and the IoT Client App. As described in FIG. 1, there are four main components in the general system architecture. The first component is the IoT Client App, which is an interface for a user to connect with the whole system. The IoT Client App includes an onboarding module for a Robot, a Robot control module, and a Robot SDK (“Software Development Kit”) Node Mobile. The second component is an IoT Cloud that supports the IoT Client App service APIs, serves as an MQTT broker to communicate with the IoT devices, and also supports file or media streaming using WebRTC (Web Real-Time Communication). The third component is a ROS2 Robot (e.g., a robot that is using ROS2). The fourth component is the Robot SDK Node that will handle onboarding process for Robot. The Robot SDK Node will also bridge the communication between the Robot, which uses a DDS communication protocol, and the IoT Cloud service, which uses MQTT communication. This component will also enable the ROS2 Robot to stream media or audio video (AV) file to a device using a Local Area Network (LAN), if both the robot and the device are connected on the same network, or via internet. The fifth component is the IoT Device that can communicate with the IoT Cloud.

According to an embodiment, the system and method will bridge communication between the ROS2 Robot and the IoT Cloud, and enable direct and indirect media streaming, using the Robot SDK to process command data, media data, action data, and collaborative bridge and validation processes. One or more embodiments will enable direct control of the ROS2 Robot using the IoT Client App. The system means a series of processes. The processes included in the system are:

A Robot Configuration process to create robot apps using a Developer Workspace, including inputting a robot serial number, a device identification, a public key, and a task list into the IoT Cloud. The Robot Configuration process will be done at first before the ROS2 robot is ready to be used. All of the communication bridge features are created in this process. Then, this feature will be set up automatically on a Robot Onboarding mechanism process.

The Robot Onboarding Mechanism process onboards a new robot with the IoT Client App, and implements the Robot SDK to configure communication among the robot and the IoT Cloud. The Robot Onboarding Mechanism process is after the Robot Configuration process. Through The Robot Onboarding Mechanism process, all of the communication bridges will be activated between the RO2 Robot, the IoT Cloud, and the IoT Client App. IoT Client App means an application that installed in the user's smartphone.

The Robot Operational process handles robot operation in real time by creating an integrated bridge inside the Robot SDK Node to communicate with the ROS2 Robot, the IoT Cloud, and the IoT Client App. The Robot Operational process means that after the Robot Onboarding mechanism process is successful, the user can operate the ROS2 robot in real time with all of the features.

The IoT Controller UX (User Experience) Component Generation process is to generate a custom page in the IoT Client App to control the Robot based on the robot's capabilities. Generating a custom page means that the IoT Client app Dashboard visualization is set up by the IoT Controller UX (User Experience) Component Generator process. The custom dashboard will be created automatically after the Robot Onboarding mechanism process is successful.

The First Step is done before the ROS2 robot is ready to use. Here, all of the communication bridge features are created in this step. Then, the communication bridge features will be set up for the Robot Onboarding mechanism process.

Robot apps refer to software that is installed inside the robot. The IoT Client app refers to software or an application that is installed inside a user's smartphone.

The software included in the robot app is installed in the operating system Robot.

This software is installed during a configuration process by the manufacturer.

The Robot Operational process means that after the Robot Onboarding mechanism is successful, a user can operate the ROS2 robot in real time with all features.

The RO2 Robot has many working nodes. One of these nodes is a Robot SDK Node that is specially created by the SDK. This means, the SDK will create a special node referred to as the SDK Node. The SDK node will have a content communication bridge feature as previously discussed.

The custom page is shown on the IoT Client App. Here, “custom” means the page will be customized based on robot capabilities. Since each robot can have different capabilities like a Robot Vacuum cleaner, etc.

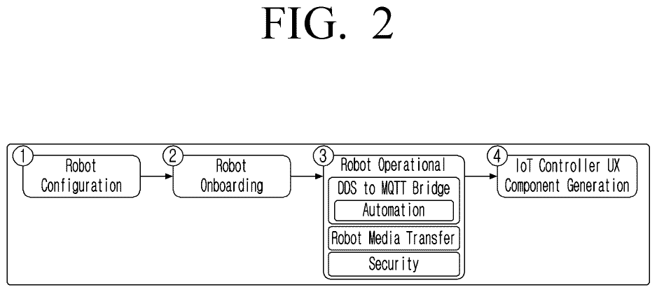

FIG. 2 describes a process for creation of the Robot SDK Node. There are four components needed to create a Robot SDK Node. The first component is for performing a Robot Configuration process, which is a process for creating robot apps using the Developer Workspace, and includes inputting a robot serial number, a device ID, a public key, and a task list into the IoT Cloud. The second component is for performing a Robot Onboarding mechanism process to onboard the new robot with the IoT Client App by connecting to WiFi, linking with the owner's account, and registering to the IoT Cloud. The third component is for performing the Robot Operational process, which is a process that runs after the robot has finished the onboarding mechanism process and is ready to use. The robot operational process includes three features. The first feature is a DDS to MQTT Bridge, created to bridge the communication between the DDS, which is used by ROS2 Robot, with MQTT, which is used by the IoT system. This makes sending a command and receiving a latest status of the ROS2 Robot from the IoT Cloud possible, and thus enable a controlling of the robot from the IoT Cloud. This feature also enables the Automation function, which includes IoT features to control one or more IoT devices. The Automation includes Routine and Scene features. Routine is a feature to automate device control based on a triggering condition, while scene is a feature to perform multiple control commands that are triggered manually. The second feature is a Robot Media Transfer feature, which is a feature to send real time AV media from the robot to the IoT Client App by implementing a DDS to WebSocket bridge for transferring media data. This feature will enable the live streaming function from the robot to the IoT Client App. The third feature is a security feature that is needed to handle the communications between the Robot, the IoT Cloud, and the IoT Client App. The fourth component is IoT Controller UX Component Generation, a feature to handle a plurality of robot capabilities. The IoT Client App can have a custom page for controlling the robot that is generated based on the robot capability.

The new robot means a robot that is newly bought, so it needs to be activated and registered on the IoT Server. The new robot is a newly bought ROS2 Robot. After finishing the onboarding process, the robot is able to proceed to the operational state.

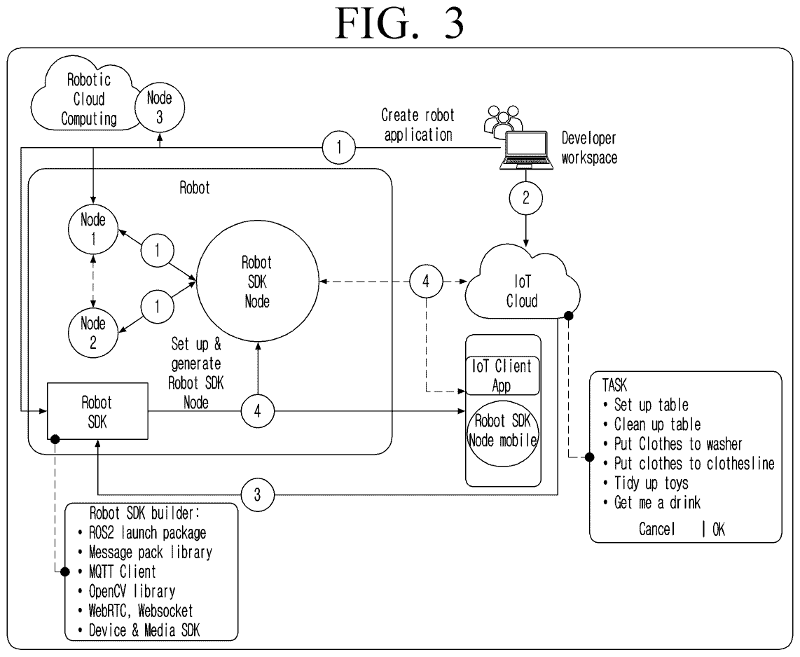

FIG. 3 describes the process for robot configuration. Several steps must be done before connecting the Robot to WiFi and the IoT Client App. The first step is to create the robot application node, the topic, and the task algorithm by implementing a sequence, Artificial Intelligence for a task, a Robot SDK, and DDS security integration. The ROS2 topic name and data should match with the task list or the device event. This step will build all of the robot configuration for action, and the robot status. An optional step is to add a Cloud Node 3 for additional computation if needed. The second step is to predefine a task (device event), generate and register a serial number, a device ID, a public key, and a task list on the IoT Cloud. The third step is to implement a serial number, a device ID, a public key, and a task list in the Robot SDK. The Robot SDK will generate the Robot SDK Node automatically when connecting the robot to WiFi and the IoT Client App. The last step is to set up and generate the Robot SDK Node for the ROS2_MQTT bridge, the ROS2_WebSocket bridge and various other parameters. This process will build the ROS2 and MQTT connection bridge, topic pair, device information, a configuration file, a serial number on both of the robot device and the mobile device, and also build the ROS2 node on the mobile device for media direct streaming.

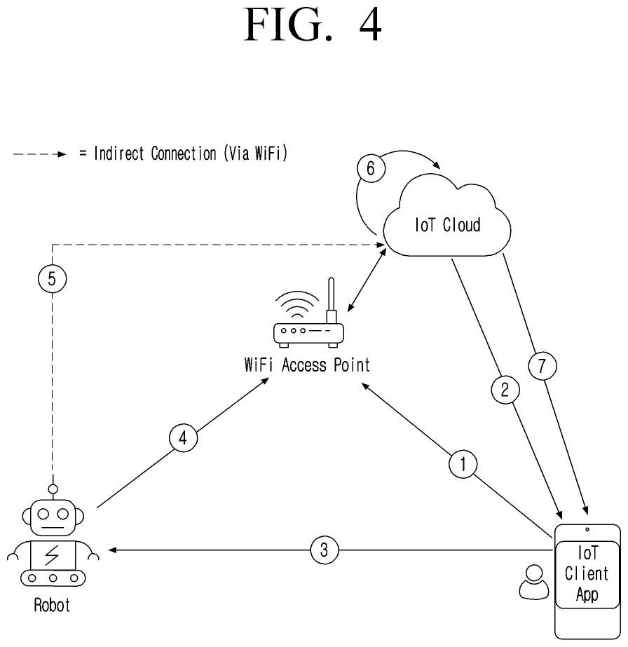

FIG. 4 describes the process for robot onboarding. After completing the configuration process, a user can onboard the robot to connect it to the IoT ecosystem. There are two main processes for Robot Onboarding. The first process is to connect the Robot to WiFi., and/or a mobile phone able to connect to WiFi with a certain configuration such as SSID, passphrase and encryption type. The IoT Client App will retrieve the IoT Cloud and user information, such as the IoT Cloud, the Robot SDK parameters, the auth provider, a user's access token, and a user's refresh token. These information will be referred to as the cloud configuration. The IoT Client App will push the WiFi and the cloud configuration to the robot. If there are several WiFi access points in the area, then the IoT Client App will provide all the WiFi that the robot can use. The robot will then connect to WiFi with one of the given WiFi configurations. The second process is to connect the robot to the IoT Client App. The robot will sign up to the IoT Cloud using the device configuration such as the serial number, public key, etc, and part of the cloud configuration, such as an access token. The IoT Cloud will check the user information from a given access token, and then make a link between the robot with user data. The IoT Cloud will notify the IoT Client App that the robot is now on its ownership, then the IoT Client App can control the robot through IoT Cloud.

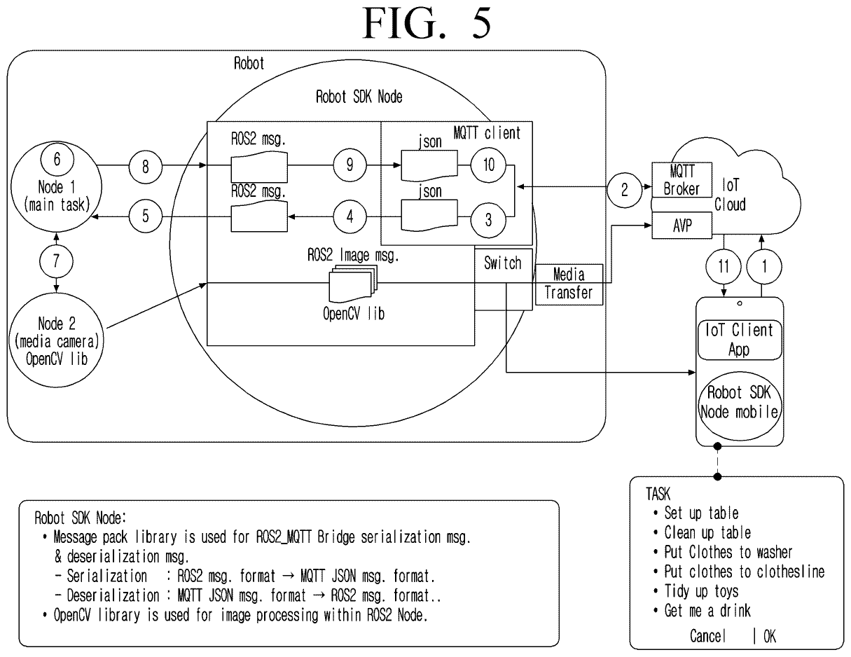

FIG. 5 to FIG. 9 describes various Robot Operational processes. The system will run all of the operations after completing the Robot Onboarding process, starting from getting the device event to the media streaming. FIG. 5 describes the process of the device event and status update flow. The first step is to send the device event, or a task. The IoT Cloud will send and receive the device event to and from the robot. The robot will receive a MQTT message, JSON and deserialize message from the MQTT message JSON to ROS2 message. The device event is then sent in a ROS2 message format. Node 1 will get a topic attribute and a value for a specific task, and do an action for a task until it is finished. Node 1 will publish and subscribe a task to Node 2 for collaboration if needed. The action result is then sent back to the ROS2_MQTT bridge, and the Robot SDK Node will serialize the message from the ROS2 message to the MQTT message in JSON format. The ROS2_MQTT bridge will send the device event to the MQTT broker on the IoT Cloud. The message is in JSON format, which includes a device ID and a serial number. The IoT Client App will then get an action or task result and status from the IoT Cloud.

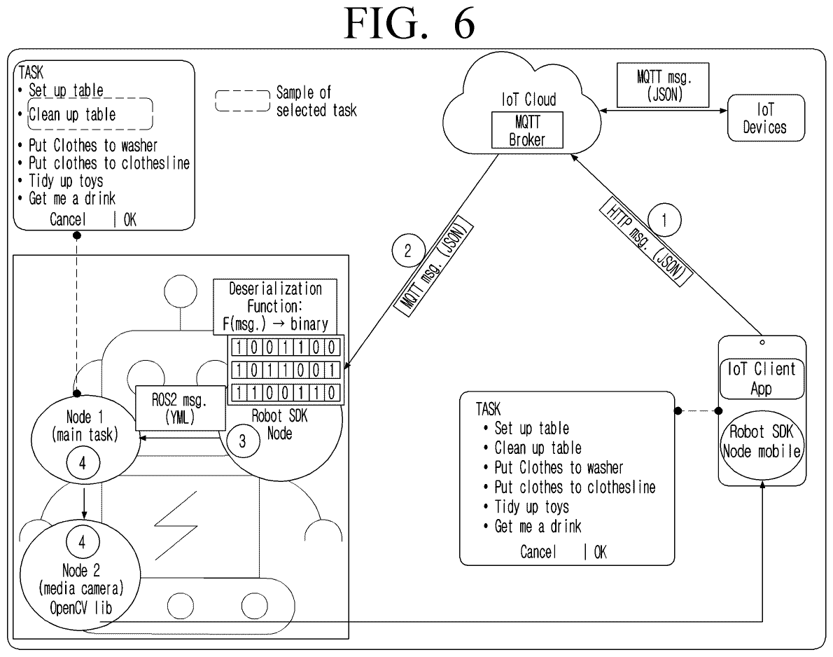

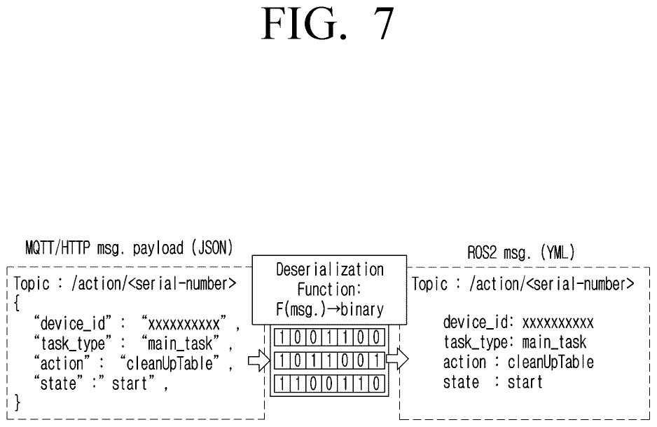

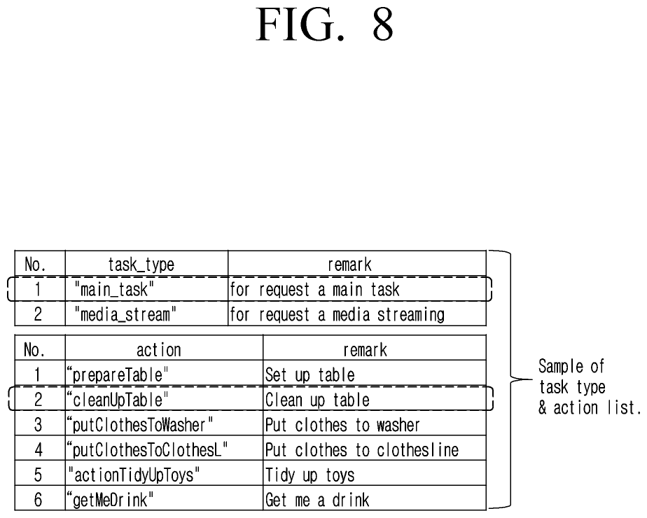

FIG. 6 illustrates the sample for getting the device event or task after connecting the robot to WiFi and the IoT Client App. The first step is to send the device event containing the topic name and content, as shown in FIG. 7. The IoT Cloud sends the device event through MQTT message. The ROS2_MQTT bridge will deserialize the topic MQTT message format to the ROS2 message format. As shown in FIG. 8, Node 1 and Node 2 will get and read a topic, then process based on a “task_type”=“main_task” and an action data value. Node 1 and Node 2 will also get and read a topic, then process based on a “task_type”=“media_stream” and action data value.

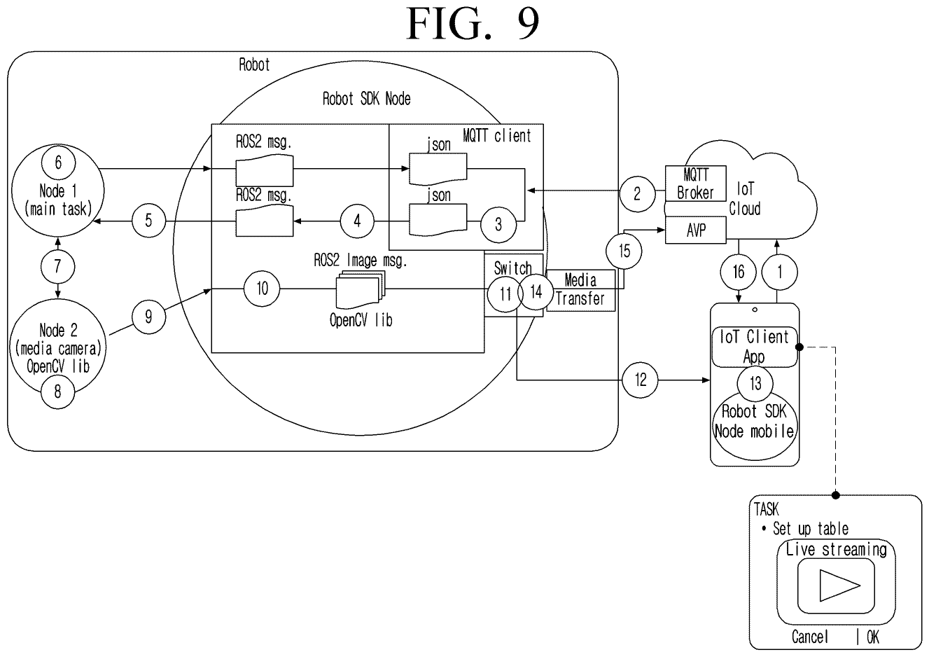

FIG. 9 describes the process for media transfer. The first step is to send a device event or task from the IoT Client to the IoT Cloud and then from the IoT Cloud to the robot. The ROS2_MQTT bridge will receive the device event from the MQTT broker cloud. The message is in JSON format, which includes a device ID and serial number. The Robot SDK Node will deserialize the message from MQTT message from JSON format to a ROS2 message format, and send the device event in ROS2 message format. Node 1 will get topic attribute and value for a specific task(e.g., media streaming), and do the action for a task until it is finish. The Robot SDK Node will request a media streaming to Node 2. Node 2 will run image processing using an openCV library in the ROS2, and get data from the robot's camera in ROS2 message format. Node 2 will send a media streaming to the Robot SDK Node in ROS2 message format. The Robot SDK Node will receive the media streaming and process. Media streaming can be switched to direct streaming via a LAN router, or indirect streaming via the internet. Media streaming is then sent to the Robot SDK Node Mobile in the ROS2 message format. The Robot SDK Node Mobile will process and get the media stream for direct streaming. For indirect media streaming, the Robot SDK Node will access the ROS2_websocket bridge and send the media streaming via HTTP/RTSP. The media stream will be processed in an Audio Video Platform (AVP) cloud, and the IoT Cloud will stream the media to the IoT Client App.

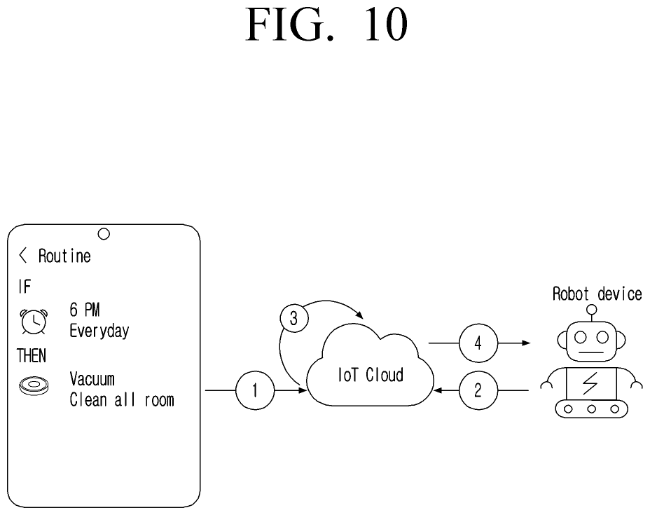

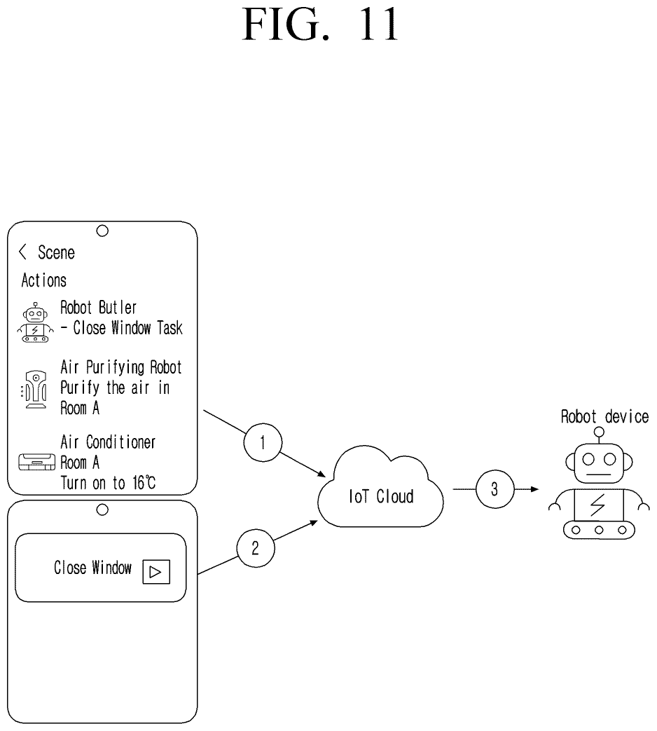

FIG. 10 and FIG. 11 describe the process for automation. Automation is an IoT feature that allows a user to control one or more IoT devices. Automation includes routine and scene features. The routine feature automates control of devices based on triggering condition. Meanwhile, the scene feature is a feature to do multiple control commands that are triggered manually.

The routine feature is triggered automatically when a certain condition is fulfilled. The routine feature configuration contains IF and THEN. IF is the condition that needs to be fulfilled before the action (THEN) is executed. THEN is the action that will be executed when the condition (IF) is fulfilled. As shown in FIG. 10, the IoT Client App can create, update or delete the routine feature configuration. The robot will update the current status to the IoT Cloud. Then, the IoT Cloud can check if the condition is fulfilled from the time schedule or the robot status or the IoT device status. The cloud will send the command to the robot if the condition is fulfilled.

FIG. 11 describes the process flow for the scene feature. Scene is an automation feature that is triggered manually. The scene configuration contains only an action. The action will be executed when the scene is triggered manually from the IoT Client App. The process starts by configuring the IoT Client App to create, update or delete a scene configuration. The IoT Client App can trigger IoT Cloud to run the scene, and the IoT Cloud will send the command to the robot when the scene is triggered.

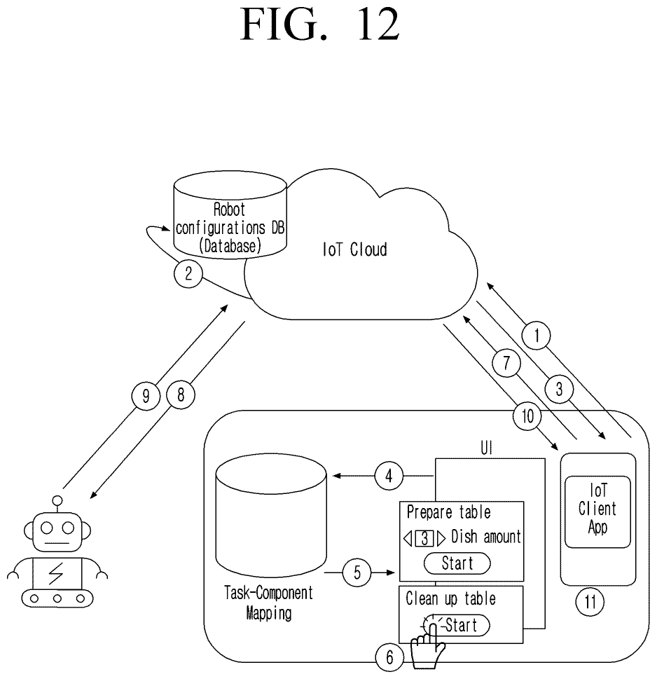

FIG. 12 describes the generation of a UX component on the IoT Client App. The first step is to get a robot's list of supported tasks by serial number, for example topic/robot/<serial-number>/supported-tasks. The system will look up the robot's configurations by serial number. The IoT Cloud will respond with robot's action list, such as [“prepareTable”, “cleanUpTable”, . . . ]. For each of the supported tasks, the system will look up from the task-component mapping and subscribe to topics of each task. The next step is to place components into a device plugin. This will allow a user to interact with the User Interface (UI) on the IoT controller. The IoT Client App will send the device event for a task to the IoT Cloud, and the IoT Cloud will forward the device event to the robot and update its status, for example topic/robot/<serial-number>/prepareTable {“progress”: “66%”}. The IoT Client App will get a notification of the robot's status update based on the changes on the topic content. The IoT Client App will update the status on the IoT controller UI.

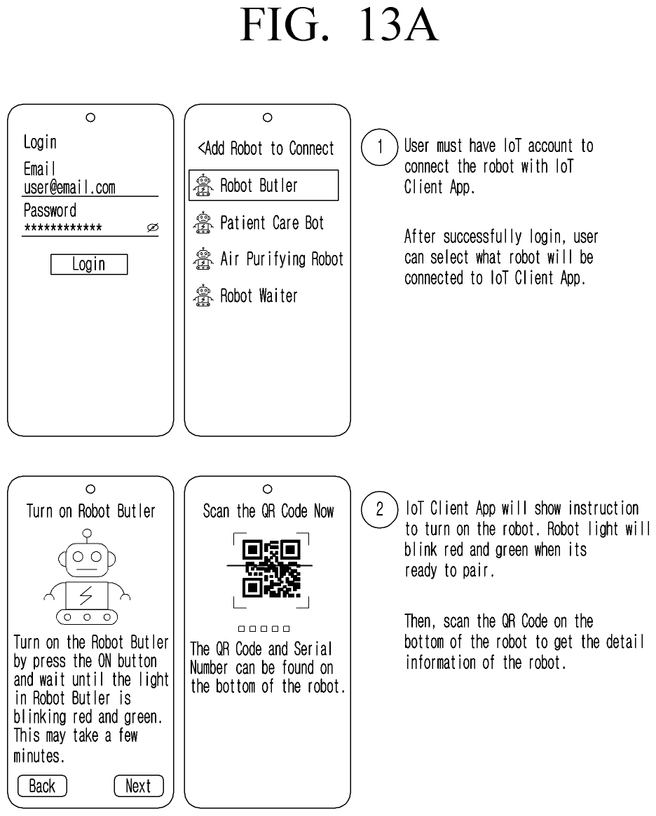

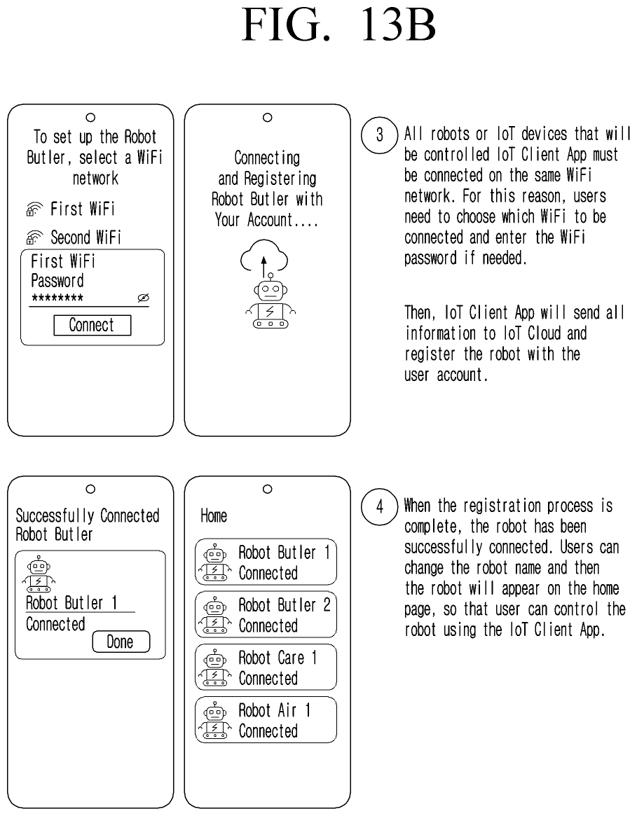

FIG. 13 A and FIG. 13B describe the illustration of the robot onboarding process of onboarding the robot to IoT ecosystem. This proposed system can be used in various cases when a user needs to integrate their IoT devices and ROS2 Robot. One or more embodiments will escalate the use of the existing IoT device and the ROS2 Robot to meet more needs of the user. As shown in FIGS. 13A and 13B, the installation of the proposed system can be done easily by the user and normally does not require any assistance from technicians during the process. The user only needs to connect the ROS2 Robot with their IoT Client App. This process is called the onboarding process. After the robot is connected to the IoT Client App, the user can easily control the robot through the IoT Client App, and can also integrate the robot with other IoT devices. One of the things that can be done to integrate is to use the automation feature available on the IoT Client App. Automation allows the user to automatically create some custom action that will be carried out by IoT Devices. In this process, robots can also be added to the automation. In general, automation can be divided into two categories, which are routine and scene features. Besides automation, users can also use the robot to monitor the robot's activity or situations around the robot.

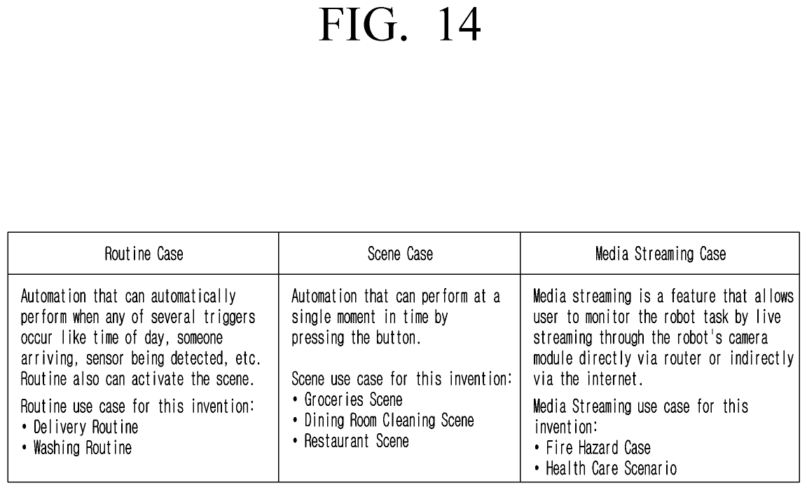

FIG. 14 describes the various use cases in which one or more embodiments can be implemented. One or more embodiments can be implemented in three different categories of scenarios. The first category is the routine case for delivery and washing laundry scenarios. The second category is the scene case for groceries, dining room cleaning and restaurant scenarios. The third category is the media streaming case for fire hazard and health care scenarios.

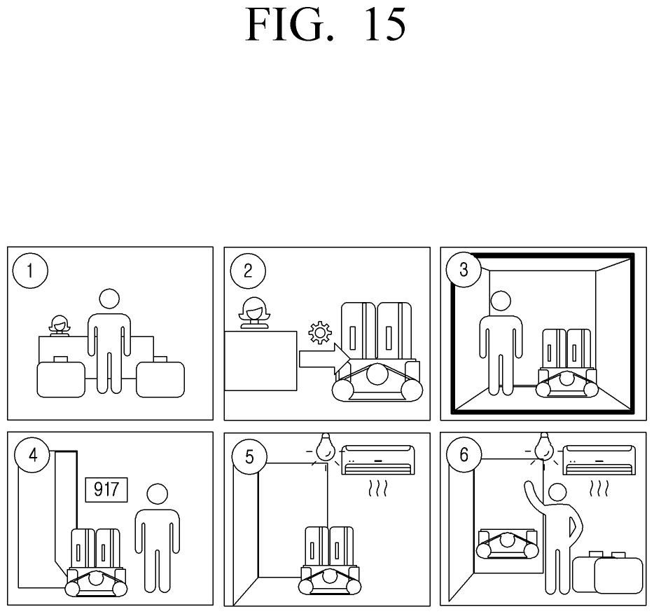

FIG. 15 to FIG. 17 describe the use case scenarios for the routine feature. The routine feature is an automation that can automatically perform when any of several triggers occur, such as a specific time of day, an arrival of a person, any sensor detected, etc. The routine feature can be integrated with a scene feature by adding the scene feature as an action of a routine. The first use case is a delivery routine in a hotel, which delivers guests'luggage to their designated room. During the holiday season, there will be a lot of visitors to visit the hotel. People on vacation usually bring many things in their luggage and may need a service from the hotel to help them carry their luggage to their hotel room. A delivery robot will be suitable to do this task.

FIG. 15 shows the process flow of the delivery robot to help deliver a customer's luggage to their room. A guest came to the hotel's reception desk to check in and brought some luggage which was quite troublesome for the guest to carry to the room. The receptionist called robot A to come, and told the guest the room number is 917, and loaded the luggage into the robot's container. The receptionist input the room number into the IoT Client App, which will generate four steps of automation for the robot and the IoT infrastructure. The first step is when robot A entered the elevator X, elevator X will then prepare to move up to the 9th floor and wait for a few minutes, then start moving. The second step is when robot A arrived in front of room 917, it unlocked the room's door automatically and robot A entered the room. The third step is when robot A entered the room 917, then turned the lights and air conditioner on. The fourth step is when the guest said “Thank you, robot” or robot A has been idle for 10 minutes, then the robot has to return to the receptionist.

After receiving the automation command, Robot A will then accompany the guest to elevator X. Once the guest and robot are inside elevator X, the IoT Cloud executes the first step mentioned previously. Once they arrive at the 9th floor, robot A shows the way to room 917. After robot A has arrived in front of room 917, the IoT Cloud will execute step two of the automation and then both the robot and visitor will enter the room. Robot A is now inside room 917 and the IoT Cloud will execute step three of the automation. When the guest unloads the luggage and says “Thank you, Robot!”, robot A will then execute the fourth step and return to the reception desk.

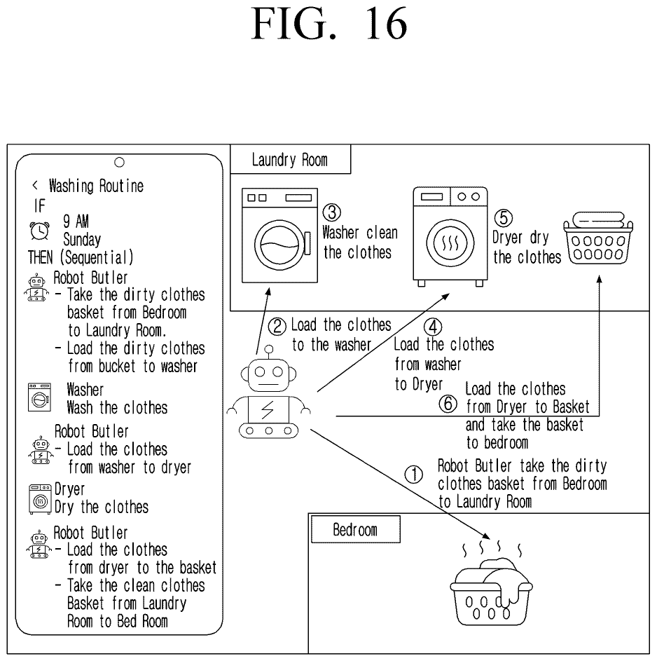

FIG. 16 describes the use case scenario for a washing laundry routine at a home environment. When doing laundry activities, users need to move clothes from the basket to the washing machine and from the washing machine to the dryer, and then return the clean clothes to the basket. These steps usually require waiting time for the washing machine or the dryer to finish the cleaning process before the user can take the clean clothes. For this reason, a Robot Butler is an important solution to help the user perform all of the mentioned tasks by integrating the robot and the IoT device to do the tasks automatically. When integrated into a routine, the Robot Butler will know when to move the clothes because the IoT devices (e.g., the washer and dryer), will send a status when it has finished the task. The IoT device can also turn on automatically because the robot can send a status when it finished loading the clothes to the washer or dryer. As shown in FIG. 16, the automation process can be done by setting up a “Washing Routine” with five steps. The first step is when the Robot Butler takes the basket filled with dirty clothes from the Bedroom to the Laundry Room, and loads the clothes from the basket to the washer. The second step is when the washer will activate a washing mode to clean the clothes. The third step is the Robot Butler loading the clothes from the washer to the dryer after it is done washing the clothes. The fourth step is when the dryer will activate the drying mode. And the last step is activated when the dryer has finished the task, and the Robot Butler will load the clean and dry clothes to the basket and deliver it to the bedroom.

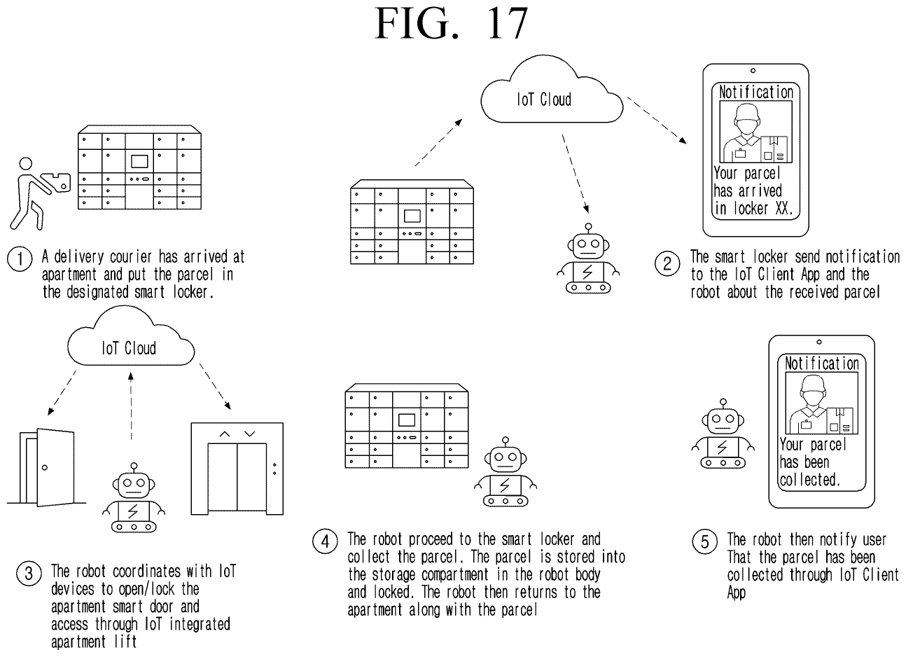

FIG. 17 describes the use case scenario for a delivery routine in an apartment. Apartments have been the primary choice of home, especially for people living in big cities where space is limited. Unlike a normal house, most apartments usually are heavily integrated to current IoT systems and also have very tight security systems and rules, which prohibit strangers or unregistered people from entering the premise. Whilst the security system and rules are essential for the comfort of the people living in it, some people may find it rather bothersome since delivery couriers will be stopped before entering the apartment premise. An internet integrated delivery robot will be suitable for the task of collecting parcel and delivering it to a user's apartment unit without the need for human intervention. FIG. 17 illustrates the flow of a delivery robot in the apartment environment. The process starts when a delivery courier has arrived at the apartment and puts the parcel in the designated smart locker. The smart locker will send a notification to the robot and the IoT Client App through the IoT Cloud about the received parcel. The robot then proceeds to the smart locker to collect the parcel according to the package collection scene defined in the IoT Client App. During the collection of the parcel, the user can stream the collection process through the IoT Client App. The robot then returns with the parcel to the user's apartment and notifies the user through the IoT Client App.

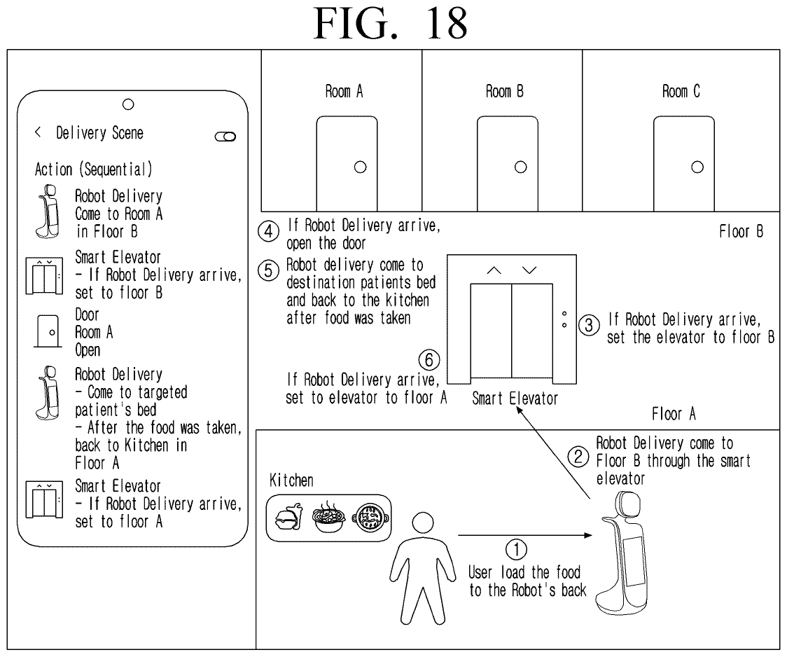

FIG. 18 to FIG. 21 describe the use case scenarios for the scene feature. The scene feature is a saved state of one or more entities that can be instigated with a single service call. A scene allows a user to control multiple IoT devices that are connected to the IoT Cloud based on a command triggered by the IoT Client App. This feature enables the robot to operate autonomously in assisting users in their daily activity without needing much human intervention. There are several daily life scenarios that help to illustrate the benefit of the scene.

FIG. 18 describes the use case scenario for a delivery scene in a hospital area. Hospitals needs to deliver food to all of the patients every day. The nurses or hospital staffs traditionally do this task, but it is highly inefficient since the hospital usually has more than one floor, and a lot of nurses or hospital staff are needed to services the number of patients in a hospital. Furthermore, nurses or hospital staff also have urgent matters that they need to attend to (e.g. when a patient's condition suddenly deteriorates and requires immediate attention). As such, in the aforementioned situation, a well-integrated autonomous robot delivery with IoT Devices can be an option to improve the efficiency in the hospital environment. In order to achieve this, a robot delivery needs to be integrated with the IoT Devices, like a Smart Elevator or a smart door, so that it can deliver foods to patients on any floor seamlessly. As shown in FIG. 18, the process flow of the delivery scene starts when the user activates the Delivery scene after loading the food to the Robot's back and sets the destination room, for example Room A in Floor B, and inputting the patient's bed information. Since the patient's room is on a different floor than the robot, the robot delivery then goes to the Smart Elevator in order to reach the destination in Floor B. Once the robot has arrived in front of the Smart Elevator, it will update its status and set an elevator destination to Floor B. After the elevator has arrived on the destination floor, the robot delivery gets off and proceeds to Room A to deliver the food for the patient. Once the food is taken, the robot delivery then returns to the kitchen using the Smart Elevator.

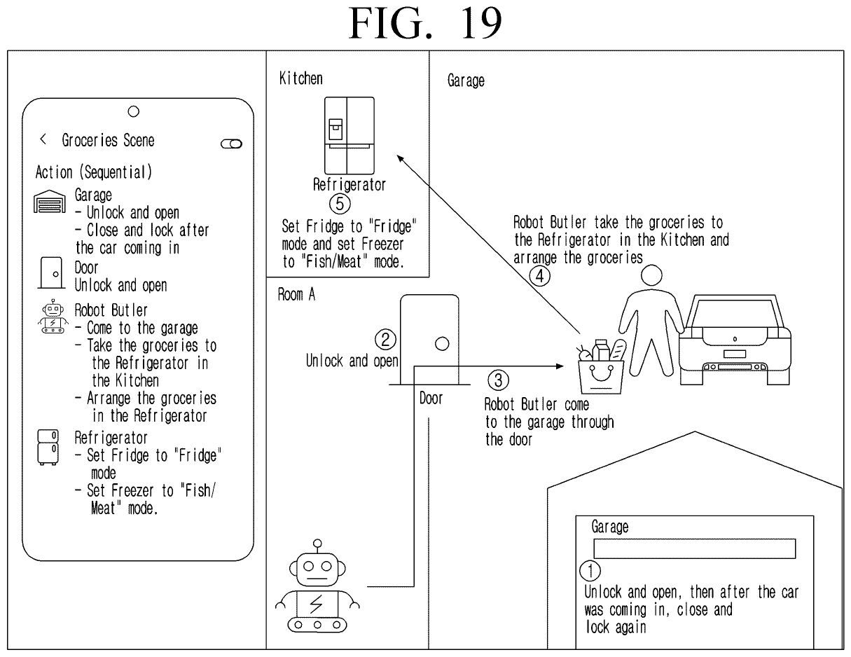

FIG. 19 describes the use case scenario for a groceries scene at a home environment. When doing grocery activities, such as organizing the food ingredients one by one into the refrigerator, is cumbersome. The use of the Robot Butler to do the task is more convenient, and with the integration of robots and IoT devices, users do not need to find the presence of the robot to give groceries to the robot. This task can be combined with other IoT Devices, such as an automated garage door, so that the user can enter the house more conveniently. FIG. 19 illustrates the automatic process for the groceries scene. The process starts when the user approaches the house after buying groceries, the garage door will automatically unlock and open to let the user enter the garage. Then, the garage door closes down and locks automatically when the car is inside the garage. The Robot Butler will be activated and directly go to the garage by unlocking and opening the smart door. Then, the Robot Butler will take the groceries to the Kitchen and arrange the groceries in the Refrigerator. The Refrigerator will automatically set to a “Fridge” mode for the refrigerator and a “Fish/Meat” mode for Freezer.

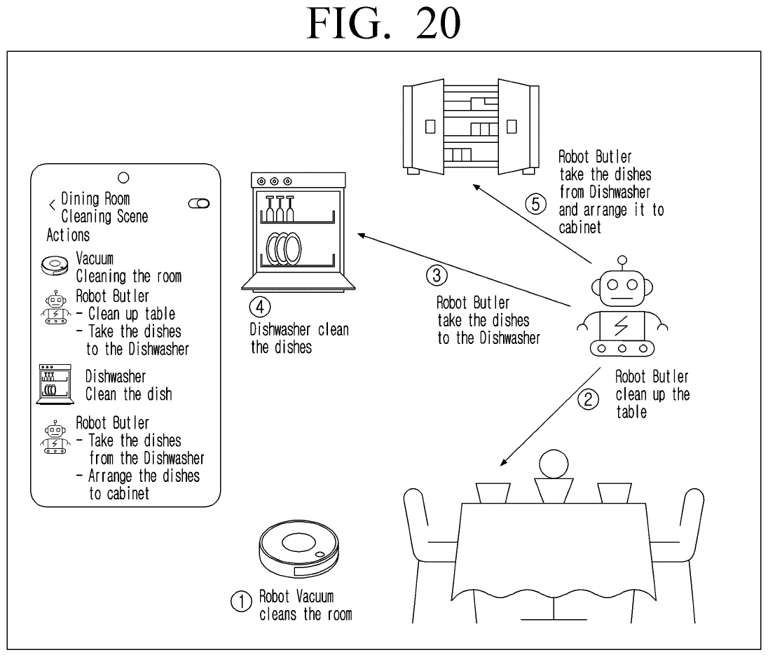

FIG. 20 describes the use case scenario for a dining room cleaning scene at home. Cleaning dirty dishes after eating together with family can be a cumbersome task, especially when a lot of dishes need to be cleaned. A dishwasher can help to clean the dirty dishes automatically, but users still need to bring the dirty dishes from the table to the dishwasher. The user also needs to wait for the dishwasher to finish its job before the user can take the clean dishes from the dishwasher and arrange them in the cabinet. All of these tasks can be performed by the Robot Butler that is integrated with a smart dishwasher so that the user does not need to waste time waiting for the Dishwasher. This task can also be combined with other IoT devices such as a Robot Vacuum to clean dirt under the dining table. As shown in FIG. 20, the automation process can be done by creating the “Dining Room Cleaning Scene”. The first step is to activate the Robot Vacuum to clean the room. Next, the Robot Butler will clean up the table and take the dishes to the Dishwasher. The Dishwasher will automatically clean the loaded dishes. The Robot Butler will unload the clean dishes from Dishwasher and arrange it to the cabinet.

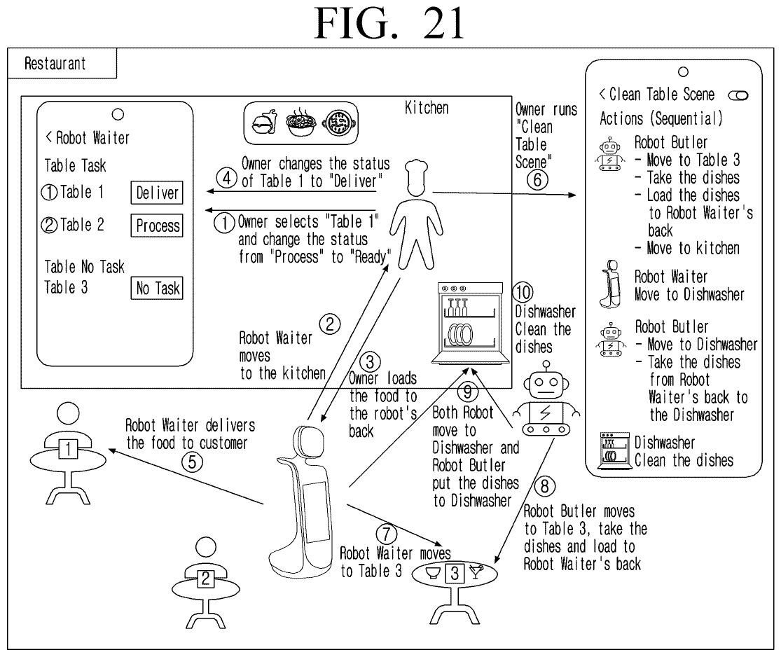

FIG. 21 describes the use case scenario for a robot waiter in restaurant. A robot waiter can deliver food automatically, and could increase the customer's satisfaction with the new experiences. By integrating a robot and an IoT Device, the robot waiter can work with the Robot Butler to help a restaurant owner deliver food to customers and clean the tables. As shown in FIG. 21, the restaurant owner can set the scenes for all of the robots and IoT devices. Firstly, the owner can call the robot to come to the kitchen to deliver food to the customers. The owner can call the robot using the IoT Client App by choosing the destination table and changing the status from “Process” to “Ready”. When the robot enters the kitchen, the owner can load the food to the robot waiter's back. Once the owner changes the table status from “Ready” to “Deliver”, the robot will start to deliver the food to the customer's destination table. The robot waiter also can be integrated with the Robot Butler to clean the table using the scene feature in the IoT Client App. When the customer is done with their food and exits the restaurant, the owner can run a “Clean Table Scene” with “Sequential” actions processes. When the scene is activated, both the robot waiter and the robot butler will move to the destination table. The robot butler will take the dirty dishes and load the dishes to robot waiter's back. Both robots will then approach the dishwasher in the kitchen. The robot butler will take the dishes from the Robot Waiter's back to the dishwasher. The dishwasher will automatically turn the washing mode to clean the dishes.

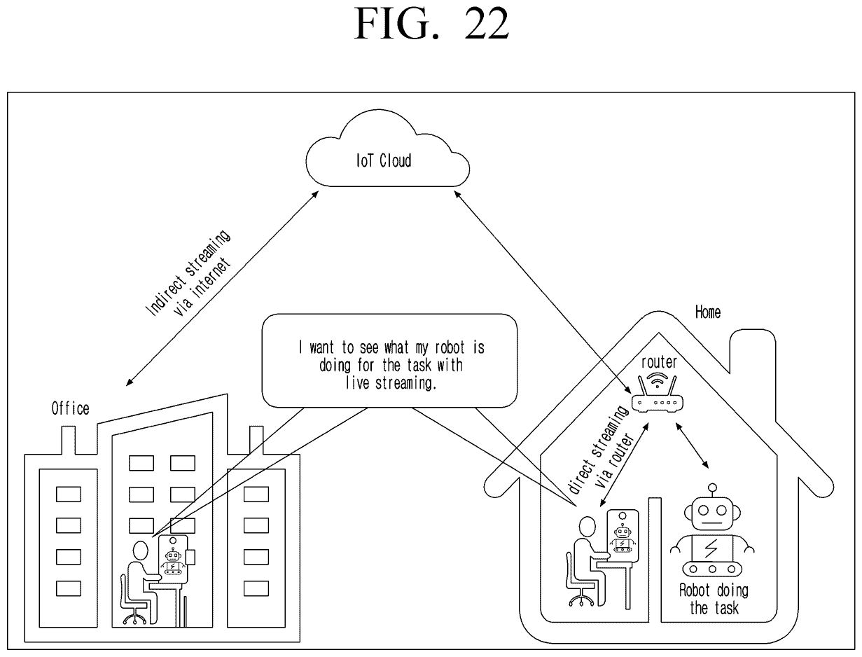

FIG. 22 to FIG. 24 describe the use case scenario for media streaming, a feature that allows a user to monitor a robot task and activity by live streaming through a robot's camera module. As shown in FIG. 22, the media streaming can be done either directly via router or indirectly via the internet. A video can be recorded to the user's client device directory in both direct and indirect streaming cases. Despite, direct streaming has more advantages over indirect streaming. Firstly, Direct streaming allows for lower latency, faster and seamless streaming compared to the indirect streaming. Furthermore, direct streaming also has the benefit of lower internet quota (bandwidth) usage while still maintaining good video quality.

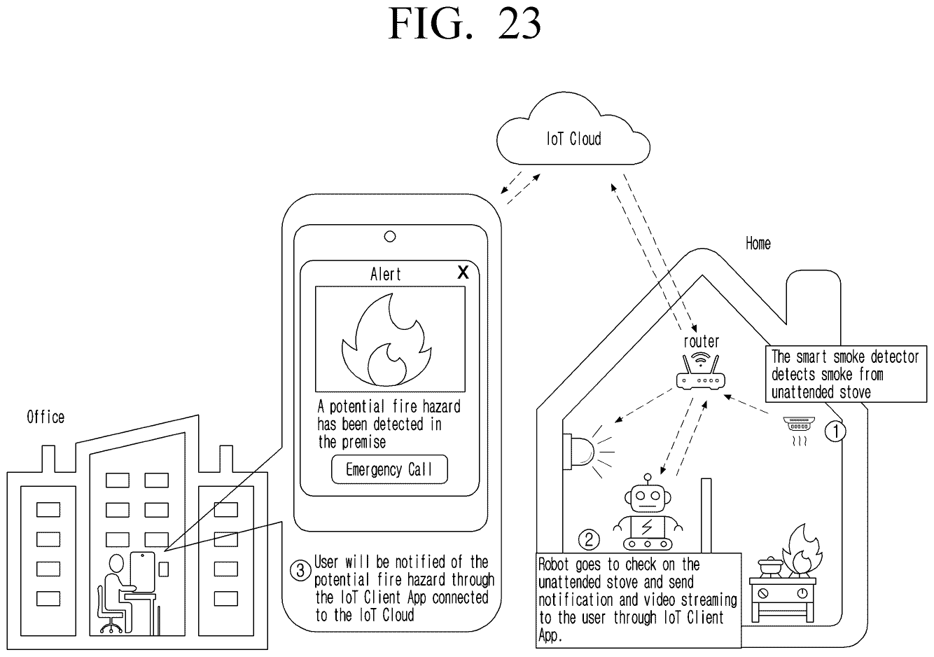

FIG. 23 describes the use case for media streaming when a fire hazard is happening at home. An unattended stove at home often leads to a fire hazard. Whilst most of the recently built houses have smoke detectors and fire alarms well integrated as safety measures, they are often subjected to false alarms or detector malfunctions. To address the aforementioned issue, a surveillance robot is suitable for the task. Unlike a surveillance camera, the surveillance robot has a mobility to patrol a predefined premise area autonomously and take action when any anomalous situation is detected. One or more embodiments will enable the smoke detector to coordinate with the surveillance robot to check and ascertain the room in which the fire is detected and provide a live stream feed of the situation to the user on the IoT Client App. As shown in FIG. 23, the surveillance robot can prevent a fire hazard in a home premise. A smoke detector will sound the alarm when smoke appears from the unattended stove and is detected by the smoke detector. Upon receiving a signal from smoke detector, the surveillance robot goes to check on the smoke location. The robot then sends a notification to the user through the IoT Client App and a live video stream to the current situation through the robot's camera module. Upon receiving a notification alert and the live video stream from the surveillance robot, the user can decide whether to contact the fire department or deactivate the alarm and dismiss it as a false signal.

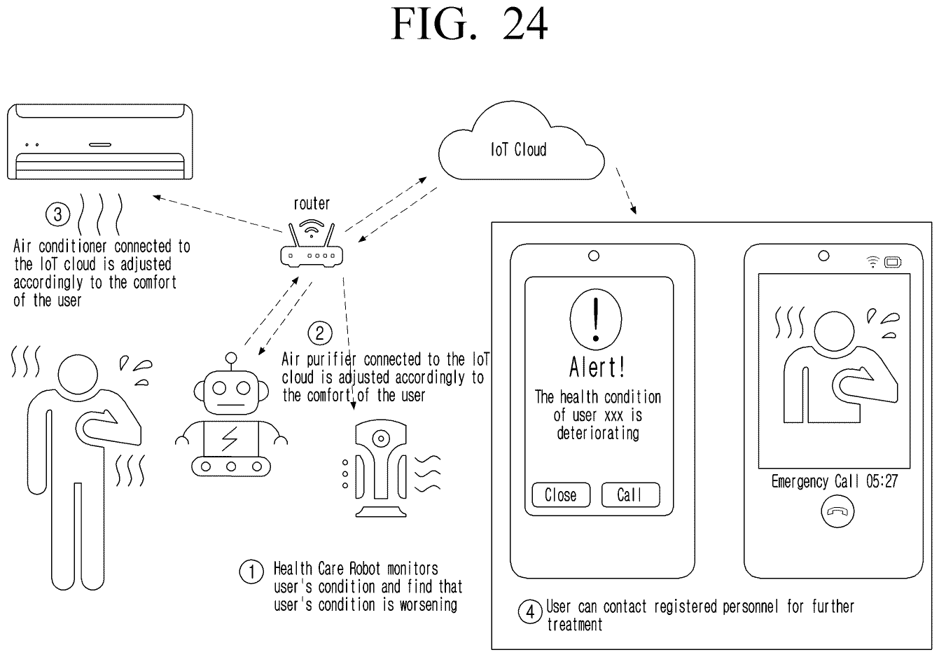

FIG. 24 describes the use case for a health care robot that helps its user to manage their daily routine and health condition. The health care robot can be used at home or an elderly care house to help monitor a user's condition. In order for the health care robot to perform its tasks and routine, the health care robot should be capable of interacting with other IoT Devices, such as an air purifier and an air conditioner, through the IoT Cloud to ensure the comfort of the user. As shown in FIG. 24, the health care robot can be used to take care of a patient with respiratory problems. In this case, the health care robot monitors the user and finds that the user's condition is worsening. In order to help the user's condition, a routine to adjust the room condition according to the ideal room temperature and room humidity is triggered by the warning sent from the robot to the IoT Appliances, such as the air conditioner, the air purifier, the air dehumidifier, etc., through the IoT Cloud. The IoT Appliances are adjusted according to the predefined routine to suit the user's health condition. The robot then sends an emergency notification through the IoT Client App to notify registered personnel. The user then can contact the registered personnel by using the robot's camera and display for further treatment.

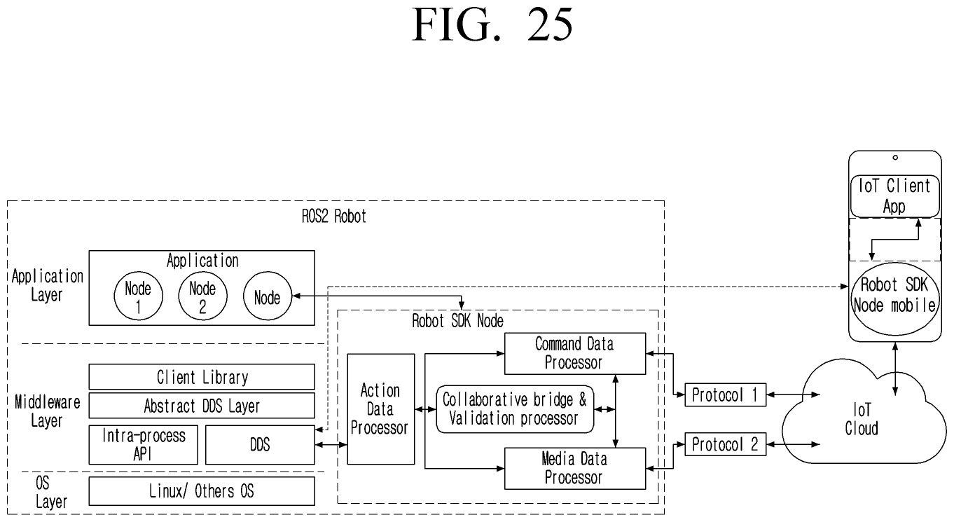

FIG. 25 to FIG. 32 describe a Robot SDK module, the main component of an embodiment. Robot SDK module will configure the communication system automatically through the Onboarding Process. The user of the robot only needs to do the onboarding process at the first time. After that, the robot is ready to do tasks. The user can control the ROS2 Robot using the IoT Client App. The developer needs to download and save the Robot SDK into the Robot's system before it is ready to do the onboarding process. The Robot SDK module will be installed inside the ROS2 Robot and the IoT Client App. The developer workspace is provided to all of the developers who want to connect their robots to the IoT Ecosystem. A developer will define parameters to the robot SDK depending on their needs, such as a task, a topic, a serial number, a private key, and a public key for security. The onboarding process will run the Robot SDK to configure the Robot SDK Node and the Robot SDK Node Mobile automatically. The Robot SDK module is built with integration between the ROS2 packages and some libraries, which include ROS2 launch packages, a message pack library, an MQTT Client, a Web Server, an OpenCV library, a Websocket, a WebRTC, and a Device and Media SDK.

FIG. 25 describes the integrated bridge inside the Robot SDK Node. The integrated bridge in the Robot SDK Node is implemented to communicate among the ROS2Robot, the IoT Cloud and the IoT Client App. The ROS2 Robot uses DDS as Middleware Protocol, and Nodes for processing on the Application Layer. The integrated bridge methods inside the robot SDK Node include four main modules, which are a Command Data Processor, a Media Data Processor, an Action Data Processor, and a Collaborative Bridge & Validation Processor. The Command Data Processor is utilized to handle Protocol 1 (e.g., MQTT protocol), while the Media Data Processor is utilized to handle protocol 2 (e.g., HTTP/RTSP) via web socket. The IoT Cloud is used to process instructions and communicate between the ROS2 Robot and the IoT Client App.

The Robot SDK Node is built inside the robot itself. It is configured automatically through the onboarding process. The integrated bridge in the Robot SDK Node involves some communication protocols such as DDS, MQTT as Protocol 1, and HTTP/RTSP as Protocol 2. With the possibility of a single point of failure happening, the Collaborative Bridge & Validation Processor is implemented to ensure that the system is running well every time and to reduce the possibility of single point of failure, and also to validate the incoming message in the Robot SDK Node. The Action Data Processor will manage tasks or an action mapping and execute data from the Command Data Processor and the Media Data Processor.

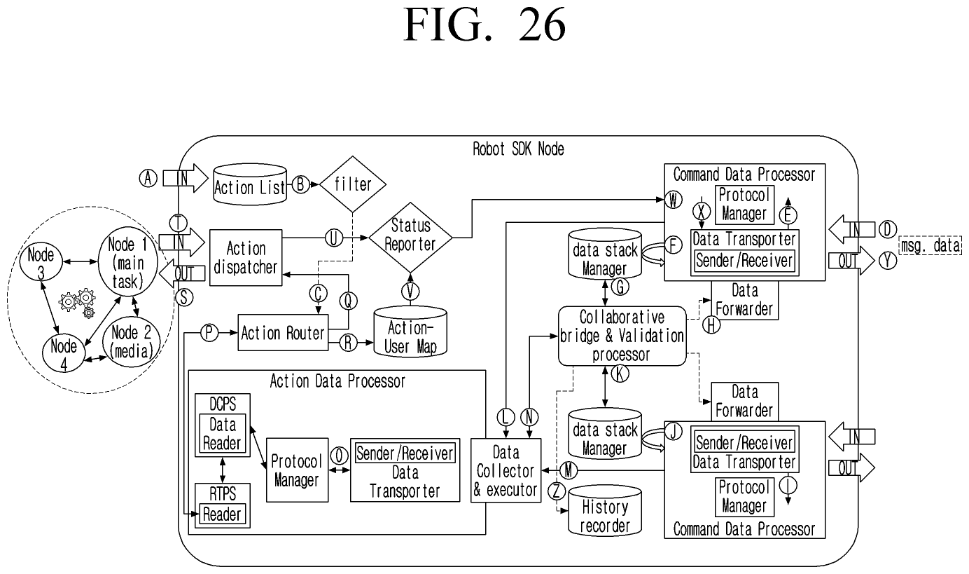

FIG. 26 describes the process of the integrated the bridge system. There are several components involved in a Robot SDK Node. The Actions List is a table written by a Robot Software Developer to store supported Action names and parameter specifications. A data transporter will receive and send data through a protocol, such as MQTT, Web socket (HTTPS/RTSP), or DDS. The protocol manager will manage each communication protocol. The command data processor will control and extract the required data, such as requester User ID, Action names and Parameters, from the Data Transporter, and construct data from a given Action, Status, and User ID into a certain format, for example JSON. An example of protocol used for a device event is MQTT. The Media data processor will control and extract required data from the Data Transporter, and construct data from a given Action, Status, and User ID into a certain format, such as JSON. An example of a protocol used for media transfer is WebSocket (HTTPS/RTTPS). The action data processor will control and extract required data from the Data Transporter, and construct data from a given Action, Status, and User ID into a certain format, such as JSON. An example of a protocol used for Action processing is DDS. A filter is implemented to filter only valid data (actions) based on supported actions from the Actions List, and parameter specifications for completeness and correctness. An Action—User Map is a table to store the Action name—requester User ID. An action router will search the action from the Actions List with a given action name, produce Action, Parameters, and a User ID, and save a requester—action pair into the Action—User Map. the action dispatcher acts as an action client, to execute a given action that will be done by other nodes. The status reporter will subscribe to the action, receive a latest status from the certain action, find the action and requester User ID, then send the Action-Status-User ID pair to the Command Data Processor. The Collaborative Bridge & Validation processor will manage and validate every incoming message data based on the timestamp, instruct to data forwarder, manage the data from the Data Stack Manager, instruct the Data Stack Manager to resend the message data several times if the data fails to flow, and instruct to execute the data. The data forwarder will forward the message data to the Media Data Processor and vice versa for collaborative bridge purpose. The data collector & executor will collect a message data timestamp, calculate the difference of a timestamp of an incoming message data from the Command Data Processor & Media Data Processor, then execute the data if the data is valid and cancel if the data is not valid. The Data Stack Manager will save and add a timestamp to every last incoming message and resend the message data several times if the data fails to flow. The history recorder will record all timestamps and the difference of the timestamp for every incoming message data. This can be used to monitor the Robot SDK Node performance, stability, and track unusual behavior in the system. The Data Centric Publish Subscribe (DCPS) is for managing collection of data. The Real Time Publish Subscribe (RTPS) is for publishing and subscribing data.

As shown in FIG. 26, there are four main modules in the integrated bridge system, which are a Command Data Processor, a Media Data Processor, an Action Data Processor, and a Collaborative Bridge & Validation Processor. The Command Data Processor's main task is to control incoming data and transmit output data for the device event from the IoT Cloud via MQTT. The Data Transporter will forward the received data to the Command Data Processor. The Protocol Manager will manage the protocol, and bridge the different protocols, such as MQTT data to DDS data. The Data Stack Manager will store the last incoming data, add a timestamp and resend the data to the Action Data Processor if the data failed to flow. The Data Forwarder will forward the data to the Media Data Processor for collaborative bridge purposes. The Status Reporter will then get the current state status of the robot action. The Media Data Processor controls the incoming data and transmits output data for media streaming from the Robot and/or device event from the Command Data Processor. The Data Transporter will forward the received data to the Media Data Processor. The Protocol Manager will manage the work of the protocol, and bridge the different protocols, for example DDS data to HTTPS/RTSP data, or MQTT to HTTPS/RTSP. The Data Stack Manager will then store the last incoming data, add a timestamp, and resend the data to the Action Data Processor if the data fails to flow. Action Data Processor manages action mapping and executes data from the Command Data Processor and the Media Data Processor. The Data Collector & executor will collect and calculate data based on Δtimestamp from the Command Data Processor and the Media Data Processor. The Protocol Manager will manage the protocol. The DCPS will manage and read action data. The Action Router will find a Node and merge the data, then send it to the Action Dispatcher. The Action-User Map Table will store and map the action data. The Collaborative Bridge & Validation Processor manages the data flow and verification. The Collaborative Bridge Processor will manage the data flow among the Command Data Processor, the Media Data Processor, and the Action Data Processor. The Validation processor will validate the incoming Δtimestamp data from the Command Data Processor & Media Data Processor. The history recorder will record a timestamp “ΔHH:mm:ss:SSS0”, “ΔHH:mm:ss:SSS1”, and Δt, for example for the data of the last 100 message.

Following is the sample process of the Robot SDK Node according to the alphabet of A to Z in FIG. 26. In the Robot Configuration stage, the robot retrieves the Node Actions configuration from the IoT Cloud, after the Robot Developer set them up from the Developer Workspace. The filter will populate itself with actions from the Node—Actions Map. The Action Router will populate itself with Node—Action pairs from the Node—Actions Map. The Robot SDK Node, through the Data Transporter will receive the data from the IoT Cloud, for example via MQTT. The Data Transporter will then forward the requester the User ID and the payload, to the Command Data Processor. The Command Data Processor will process and extract the requester User ID, Action and Parameter. Then, a timestamp will be added, for example “timestamp”: “HH:mm:ss:SSS”, with HH for hours, mm for minutes, ss for seconds, SSS for milliseconds and nanoseconds. The Data Stack Manager will store the last incoming message with its timestamp several times and resend the message data to the Action Data Processor if the data failed to flow. It can reduce a possibility of a single point of failure by resending the message data to the Action Data Processor if the data fails to be sent. The Data forwarder will forward the message data from the Command Data Processor to the Media Data Processor. For this case, the Media Data Processor will do a role for a collaboration bridge, managed by the Collaborative Bridge & Validation Processor. The Data Transporter will forward the requester the User ID and payload to the media Data Processor. The Data Stack Manager will store the last incoming message with its timestamp for several times and resend the message data to the Action Data Processor if the data fails to flow.

The Collaborative Bridge & Validation Processor acts as the main processor to control and trace the data forwarder execution in the Command Data Processor and the Media Data Processor. The Command Data Processor and the Media Data Processor will forward the message data with the timestamp. The Data Collector and executor will collect the message data from the Command Data Processor and the Media Data Processor, for example:
Get the Δ timestamp from Command Data Processor=“ΔHH: mm: ss: SSS0”.
Get the Δ timestamp from Media Data Processor=“ΔHH: mm: ss: SSS1”.
Δt (different time)=“ΔHH: mm: ss: SSS1”-“ΔHH: mm: ss: SSS0”.
Δt_threshold is the maximum time value to judge if the message is valid or not. Δt_threshold value can be defined manually. If Δt<=Δt_threshold, it means the data is valid and can be passed to the next step by the Validation processor and the data executor. If Δt>Δt_threshold, it means the data is not valid and cannot be passed and there will be no execution. It indicates that the robot is experiencing a problem, and a warning will be given to the robot user. The Validation processor is used to judge if the incoming message is valid or not, and to indicate if the bridge is running well. The data from “ΔHH:mm:ss:SSS0”, “ΔHH:mm:ss:SSS1”, and Δt will be stored in the history recorder. When a single point of failure happens during data transmission from the Command Data Processor to the Action Data Processor, the Collaborative bridge will still send the message data from the Media Data Processor to the Action Data Processor. This can reduce the possibility of a single point of failure.

Furthermore, the Data Transporter will forward the requester User ID and the payload to the Protocol manager inside the Action Data Processor. The Action Data Processor will process and extract the requester User ID, Action and Parameter, and then forward it to the Action Router. The Action Router will find the Node who owns the given Action, merge the Node, Action and Parameter data, and then give it to the Action Dispatcher. The Action Router will then put the Action, requester User ID data into Action—User Map table. The Action Dispatcher will execute the Action with a given Parameter. Another Node will then execute this Action. As the action client, Action Dispatcher will receive the Response or Feedback, and then forward the Action, Response, and Feedback to the Status Reporter. The Status Reporter will extract Action data and make a Status summary from the Response or Feedback. The Status Reporter will find the User ID by Action from the Action—User Map to get requester User ID, and then forward the User ID, Action, and Status to the Command Data Processor. The Command Data Processor will remove the timestamp data, and then format the Action and Status into a Payload with a certain format, for example JSON, and give the User ID and Payload to the Data Transporter. The Data Transporter will send the Payload data to the User ID through the IoT Cloud, for example via MQTT. The system will then record the timestamp “ΔHH:mm:ss:SSS0”, “ΔHH:mm:ss:SSS1”, and Δt, for example for the message data of the last 100 messages. This can be used to monitor the Robot SDK Node performance, stability, and track unusual behavior in the system.

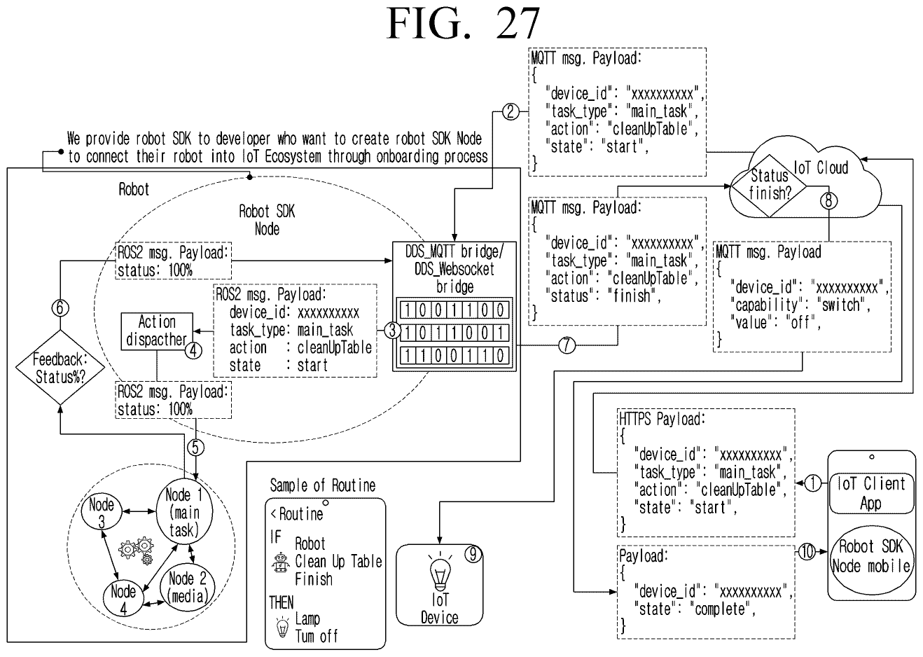

FIG. 27 describes the sample of an end-to-end converting mechanism in a Routine case. The process starts when a device event is sent from the IoT Client App to the IoT Cloud. The IoT Cloud will send the device event to the Robot. The Robot SDK Node DDS_MQTT Bridge will process the message from the MQTT message payload to the DDS message payload. The Robot SDK Node will proceed to execute a given action/task that will be done by other nodes, for example Node 1. Node 1 will get the action message for doing a task. Then, Node 1 will send feedback of a task processing status. The Robot SDK Node DDS_MQTT Bridge will process the feedback of status message from the ROS2 message payload to the MQTT message payload, and then send the message to the IoT Cloud. The IoT Cloud will get the status message. If a task status is 100% finished, or completed, the IoT Cloud will send a MQTT message payload instruction to turn off the IoT device, for example a Lamp. The IoT device will turn off the Lamp, and the IoT Client App will get the result feedback as the end of the process.

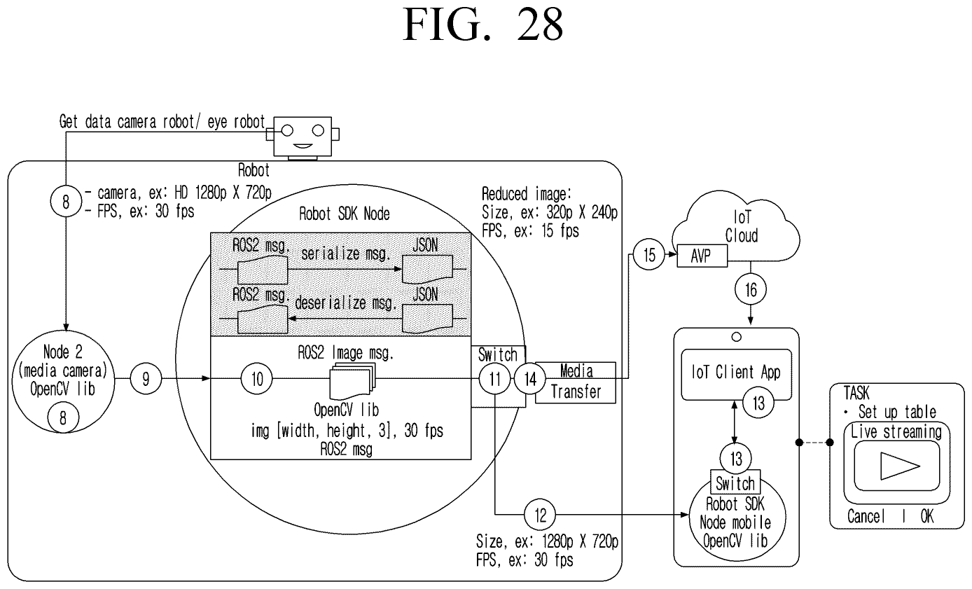

FIG. 28 describes the media transfer flow for direct and indirect stream. Media transfer method is used to handle media streaming, with two options. The first option is direct streaming via a router LAN, which will be set as a priority. The second option is indirect streaming via internet to cloud. An auto switch for the connection is applied if the mobile device does not connect to the same router LAN. As described in FIG. 28, Node 2 will get data from the robot's eye, or camera. The user can define the image RGB resolution, for example HD 1280 p×720 p, and the frame rate per second (fps), for example 30 fps. Node 2 will run the image processing using OpenCV library in ROS2, and publish a ROS2 message image of [width, height, 3] in 30 fps to the ROS2 SDK Node. The media streaming is sent to the ROS2 robot SDK Node in the ROS2 message format (e.g., standard message format). The Robot SDK Node will receive and process the media streaming. This system allows change of a media streaming connection by using the Switch. As mentioned previously, there are two options for media streaming, which are Direct streaming via a router LAN as a priority option, and Indirect streaming via the internet to cloud as a second option. an auto switch will be applied if the mobile device does not connect to the router LAN. In case of the direct stream, the Robot SDK Node will send a media streaming to the ROS2 Robot SDK Node Mobile in the ROS2 message format via the LAN router. The Robot SDK Node Mobile will process and retrieve the direct media stream. The Robot SDK Node mobile will process media by the ROS2 OpenCV lib (Open Source Computer Vision Library). In case of the indirect stream, The ROS2 message image will be converted to data media streaming by the ROS2 OpenCV lib, WebSocket, or WebRTC. The Robot SDK Node will send a media streaming via HTTPS/RTSP, and process the data in the Audio Visual Platform (AVP) Cloud. The Robot SDK Node Mobile will retrieve the indirect media streaming.

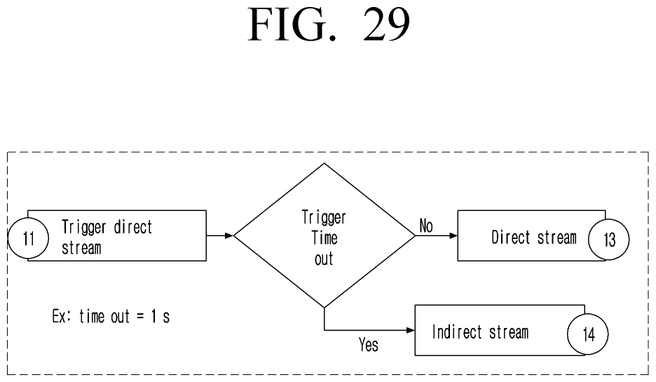

FIG. 29 describes the switch flow for direct and indirect media stream. Two possible processes will occur on the Switch for the direct stream and indirect stream. For the direct stream, the Robot SDK Node will send a media streaming to the ROS2 robot SDK Node Mobile in the ROS2 message via the LAN connection. The ROS2 message image will be converted to data media streaming. Media streaming can then be recorded in the mobile directory. For the indirect stream, the ROS2 image messages will be forwarded to the media transfer process via the internet connection. In the media transfer process, the image message will be converted into data media streaming, and proceed to IoT Audio Video Platform (AVP) Cloud.

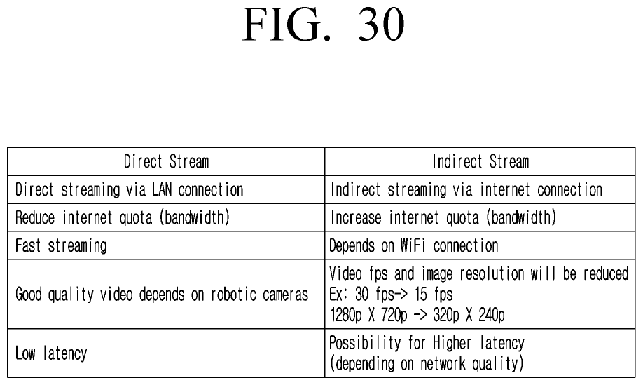

FIG. 30 describes the differences between Direct Stream and Indirect Stream. The direct stream uses the LAN connection, thus it will reduce the internet quota or bandwidth usage. The direct stream also allows for fast streaming, better quality video depending on the robot's camera, and low latency. On the other hand, the indirect stream uses the internet connection, which means it will consume more internet quota or bandwidth than the direct stream. The downside of indirect stream is that it depends on the WiFi connection. When the connection is not reliable, video fps and image resolution will be reduced, for example from 30 fps to 15 fps, and 1280 p×720 p to 320 p×240 p. There is also possibility for higher latency on indirect stream, depending on network quality.

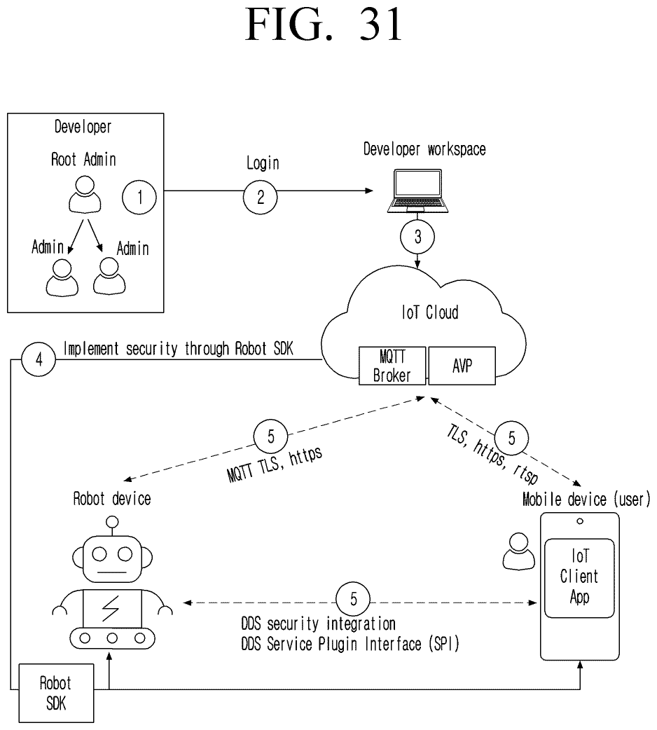

FIG. 31 describes the process for security integration. One or more embodiments use a security method that combines DDS security, HTTP security, RTSP security and TLS (Transport Layer Security). To integrate the security, a developer can create Robot Admin and Admin. Login details such as username and password will also be created. The developer can manage the access by generating serial number, generating Device ID, generating Secret Key, and TLS (Transport Layer Security). Keys for the IoT Cloud and App security use the format of “privateKey”: “xxxxxxxxxxxx”, and “publicKey”: “xxxxxxxxxxxxx”. Next, the system will implement security such as a Serial Number, a device ID, and a secret key through the Robot SDK. The system will operate security integration among the IoT Cloud, the ROS2 Robot, and the IoT Client App, which include MQTT, HTTP, RTSP, and DDS security.

The ROS2 has a DDS Service Plugin Interface (SPI), which includes three components. The first is Authentication to verify the identity of a given domain participant. The second is Access Control to enforce restrictions on the DDS-related operations that can be performed by an authenticated domain participant. The third is Cryptographic to handle all required encryption, signing, and hashing operations, such as generate and use Certificate Key, Private Key, and others.

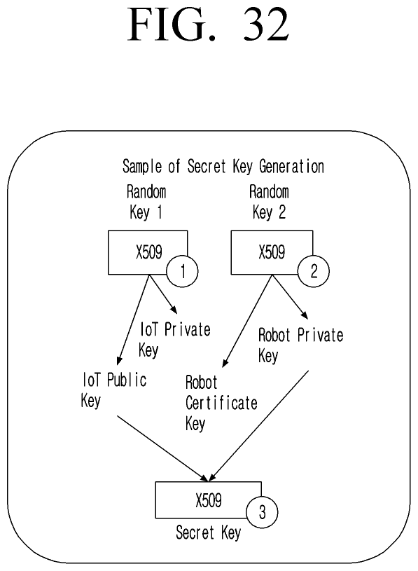

FIG. 32 describes the sample process of secret key generation using X.509, which is a standard format for public key certificates. One or more embodiments combine two sets of random keys to make unique secret key generation. The first step is to generate Random Key 1 as IoT Cloud/Client App Security based on TLS (Transport Layer Security) of MQTT & HTTP/RTSP. The second step is to generate Random Key 2 as Robot Security based on DDS security, referring to DDS Service Plugin Interface (SPI). The last step is to combine all of the keys to make unique secret key.

One or more embodiments of the disclosure may support a ROS2 Robot on IoT ecosystem to integrate the operation of ROS2 Robot and IoT devices using a single IoT Client App, and to enable the use of IoT feature on ROS2 Robot, such as automation. The system may allow a ROS2 Robot to connect to MQTT IoT Cloud without the need of additional IoT Hub.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A method of controlling for a ROS2 (Robot Operating System 2) robot, the method comprising:
enabling a control of the ROS2 robot through an Internet of Things (IoT) client application,
wherein the enabling the control of the ROS2 robot comprises:
applying a robot configuration process comprising generating a robot application using a developer workspace, and inputting a robot serial number, a device identification, a public key and a task list into an IoT cloud,
applying a robot onboarding mechanism process comprising onboarding the ROS2 robot to the IoT client application, and configuring, by a robot software development kit (SDK) node, communication among the ROS2 robot and the IoT cloud,
applying a robot operational process comprising bridging communication, the robot SDK node, among the ROS2 robot, the IoT cloud and the IoT client application, and
applying an IoT controller user experience (UX) component generation process comprising generating a page in the IoT client application, based on capabilities of the ROS2 robot, to control the ROS2 robot; and
streaming media, directly or indirectly, through the robot SDK node to process command data, media data, action data and a collaborative bridge and validation process.

2. The method of claim 1, wherein the ROS2 robot includes a ROS2 operating system.

3. The method of claim 1, wherein the IoT cloud includes an IoT server that is accessible by plurality of robots and IoT devices.

4. The method of claim 1, wherein the streaming media, directly or indirectly, comprises sending audio or video data from the ROS2 robot to the IoT client application in real time.

5. The method of claim 1, wherein the IoT client application is installed on a device for controlling IoT device, and
wherein the device is mobile phone or smart watch.

6. The method of claim 1, wherein the applying the robot configuration process further comprises:
generating the robot SDK node using the developer workspace,
installing a robot SDK before the onboarding of the ROS2 robot to the IoT client application, and
inputting the robot serial number, the device identification, the public key and the task list into the IoT cloud.

7. The method of claim 1, wherein the applying the robot onboarding mechanism process further comprises:
connecting the ROS2 robot to a WiFi that is connected to a mobile phone on which the IoT client application is installed,
connecting the ROS2 robot to the IoT client application and retrieving the IoT cloud and user information to obtain a cloud configuration,
wherein the ROS2 robot is connected to the WiFi based on one of a WiFi configuration or the cloud configuration,
connecting, by the robot SDK node, the ROS2 robot to the IoT client application to configure a communication between the ROS2 robot and the IoT cloud based on a device configuration and the cloud configuration,
obtaining user information via the IoT cloud based on an access token included in the cloud configuration,
generating a link between the ROS2 robot and the IoT client application based on the user information,
notifying the IoT client application via the IoT cloud that the ROS2 robot is linked to the IoT client application, and
controlling the ROS2 robot through the IoT cloud on the IoT client application.

8. The method of claim 1, wherein the applying the robot operational process comprises:
applying an integrated bridge inside the robot SDK node to bridge communication among the ROS2 robot, the IoT cloud and the IoT client application, wherein the integrated bridge is configured to bridge communications of IoT automation features, routine features and scene features to the ROS2 robot via the IoT client application, applying a media transfer process to send real time audio or video media from the ROS2 robot to the IoT client application using a direct and indirect media stream, and
applying a security integration process to secure communication among ROS2 robot, the IoT cloud and the IoT client application.

9. The method of claim 1, wherein the applying the IoT controller UX component generation process further comprises:
generating the page as a user interface (UI) in the IoT client application, based on the capabilities of the ROS2 robot, to control the ROS2 robot and indicate a status of the ROS2 robot, and
controlling the capabilities of the ROS2 robot based on the UI.

10. The method of claim 7, wherein the applying the robot onboarding mechanism process further comprises:
configuring the communication automatically among the ROS2 robot, the IoT cloud and the IoT client application,
building the robot SDK node with integration between ROS2 packages and at least one a ROS2 Launch Packages, a Message Pack Library, a Message Queue Telemetry Transport (MQTT) client, a Web Server, an Open Source Computer Vision Library (OpenCV library), a Websocket, a Web Real-Time-Communication (WebRTC), or a Device and Media SDK,
using the Message Pack Library for a ROS2-to-MQTT bridge serialization message data and deserialization message data to convert a ROS2 message format to a MQTT JavaScript Object Notation (JSON) message format, and to convert the MQTT JSON message format to the ROS2 message format, and
using the OpenCV library for image processing within robot SDK node.

11. The method of claim 8, wherein the applying the integrated bridge comprises:
using a command data processor to control and extract data from a data transformer, and construct a data format using an MQTT protocol for a device event,
using a media data processor to control and extract data using a WebSocket protocol for media transfer,
using an action data processor to control and extract data using a DDS protocol for action processing,
using a collaborative bridge & validation processor to manage and validate incoming message data, and
bridging communication among the ROS2 robot, the IoT cloud, and the IoT client application by using the command data processor, the media data processor, the action data processor, and the collaborative bridge & validation processor.

12. The method of claim 8, wherein the applying the media transfer comprises:
setting direct streaming via a router of a local area network (LAN) as a priority option,
based on a direct stream, sending a media streaming to the ROS2 robot in ROS2 message format via the router of the LAN,
setting indirect streaming via internet to the IoT cloud as a secondary option,
based on an indirect stream, converting a ROS2 message to data media streaming based on one of a ROS2 OpenCV library, WebSocket or WebRTC,
applying a trigger time out,
obtaining a value of the trigger time out, and
based on the value of the trigger time out being greater than a limit value, switching from the direct streaming to the indirect streaming.

13. The method of claim 8, wherein the applying the security integration process comprises:
generating a root administrator and an administrator,
logging a username and password,
generating the robot serial number, the device identification, a secret key and transport layer security (TLS),
implementing security based on the robot serial number, the device identification and the secret key through the robot SDK node, and
implementing the security among the IoT cloud, the ROS2 robot and the IoT client application, the security including of MQTT, Hypertext Transfer Protocol (HTTP) security, Real-Time Streaming Protocol (RTSP) security, and Data Distribution Service (DDS) security.

14. The method of claim 11, wherein the using the command data processor comprises:
controlling incoming input data and transmitting output data for the device event from the IoT cloud via the MQTT protocol,
using a data transporter to the input data to the command data processor,
using a protocol manager to manage a work of a protocol and bridge a different protocol,
using a data stack manager to store the input data, add a timestamp and send the input data to the action data processor based on the input data failing to flow,
using a data forwarder to the input data to the media data processor for a collaborative bridge purpose, and
using a status reporter to obtain a status of a current state of a robot action.

15. The method of claim 11, wherein the using the media data processor comprises:
controlling incoming input data and transmitting output data for media streaming from the ROS2 robot and/or the device event from the command data processor,
using a data transporter to the input data to the media data processor,
using a protocol manager to manage a work of a protocol and bridge a different protocol, and
using a data stack manager to store the input data, add a timestamp and send the input data to the action data processor based on the input data failing to flow.
